(19) United States
(12) Patent Application Publication
(10) Pub. No.: US 2009/0281865 A1
(43) Pub. Date: Nov. 12, 2009

(54) METHOD AND SYSTEM TO MANAGE A BUSINESS PROCESS

(76) Inventor: Todor Stoitsev, Darmstadt (DE)

Correspondence Address: SCHWEGMAN, LUNDBERG & WOESSNER/SAP, P.O. BOX 2938, MINNEAPOLIS, MN, 55402, US

(21) Appl. No.: 12/179,475

(22) Filed: Jul. 24, 2008

Related U.S. Application Data
(60) Provisional application No. 61/126,992, filed on May 8, 2008.

(51) Int. Cl. G06Q 10/00

(52) U.S. Cl. 705/9

(57) ABSTRACT

A system for managing a business process is provided. The system, in one example embodiment, includes a monitor, a collector, and a task pattern generator. The monitor may be configured to monitor ad-hoc events related to a task. Ad-hoc events may be associated with end-user task-management activities, such as, for example, events associated with a to-do item generated by an e-mail client module. The collector may be configured to collect data associated with the ad-hoc events related to task. The task pattern generator may be configured to generate a task pattern based on the collected data.

### CLAIM OF PRIORITY

The present patent application claims the priority benefit of the filing date of U.S. provisional application No. 61/126,992 filed May 8, 2008, the entire content of which is incorporated herein by reference.

### TECHNICAL FIELD

This disclosure relates generally to the field of business process management.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Existing tools for process modeling, e.g., TIBCO® Business Studio (TIBCO®, 2007), JBoss® jBPM (JBoss®, 2007), Soyatec® eBPMN Designer (Soyatec®, 2007), STP BPMN Modeler (STP, 2007) do not allow end-user-driven process composition. These tools require process designers to understand specific modeling notation, to explicitly enter the process modeling environment, which may be unacceptable for business users, who are focused on executing business tasks and not on modeling processes. Therefore such tools are mainly appropriate for modeling of rigid, predefined business processes by process experts (designers).

Tools for managing completely ad-hoc work aim to support knowledge workers in highly variable, non-routine tasks. Holz et al. (Holz, H., Rostanin, O., Dengel, A., Suzuki, T., Maeda, K. and Kanasaki, K., 2006. Task-based process know-how reuse and proactive information delivery in Task Navigator. Proc. CIKM 2006, ACM Press (2006), 522-531) describe a tool, which supports task-based and document-based proactive information delivery and instance-based task reuse. This approach corresponds to a comprehensive strategy for business process-oriented knowledge management.

An approach for bridging routine and ad-hoc work is presented in the form of the Workware® tool. The Workware® tool requires a proprietary environment and notation that an end-user has to learn in order to enact the process. Furthermore, research has been done with respect to process mining, where workflows can be constructed from event logs of formal and collaborative systems.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing a network environment within which a framework for end-user-driven business process management may be implemented;

FIG. 2 is a block diagram illustrating a system for end-user-driven business process management, in accordance with an example embodiment;

FIG. 3 is a flow chart illustrating a method for generating a task pattern, in accordance with an example embodiment;

FIG. 4 is a flow chart illustrating a method for generating a formal workflow model, in accordance with an example embodiment;

FIG. 5 is a block diagram illustrating a framework architecture for end-user-driven business process management, in accordance with an example embodiment;

FIG. 6 is a diagrammatic representation of example task ranges;

FIG. 7 is a flow chart illustrating a simple process flow, in accordance with an example embodiment;

FIG. 8 is a flow chart illustrating a Task Delegation Graphs (TDG) generation process flow, in accordance with an example embodiment;

FIG. 9 is a flow chart illustrating a workflow generation process, in accordance with an example embodiment;

FIG. 10 is a flow chart illustrating a workflow execution process, in accordance with an example embodiment;

FIG. 11 shows a Collaborative Task Manager (CTM) to do list, in accordance with an example embodiment;

FIG. 12 shows a Collaborative Task Manager (CTM) email inbox with task request messages, in accordance with an example embodiment;

FIG. 13 shows a tasks delegation tree structure, in accordance with an example embodiment;

FIG. 14, shows a collaborative flow overview, in accordance with an example embodiment;

FIG. 15 shows an example user interface (UI) of an Ad-Hoc Task Explorer, in accordance with an example embodiment;

FIG. 16 shows a UI of the jBPM process definition environment, in accordance with an example embodiment;

FIG. 17 shows an example UI that represents jBPM process definition environment including swimlanes, in accordance with an example embodiment;

FIG. 18 shows an example UI that represents a CTM process composition environment, in accordance with an example embodiment;

FIG. 19 shows an example UI that represents a CTM process composition environment including task evolution data, in accordance with an example embodiment;

FIG. 20 shows a UI associated with the CTM process composition environment with the selected swimlane tab and the assignment property tab, in accordance with an example embodiment;

FIG. 21 shows a jBPM web front-end Home page, in accordance with an example embodiment;

FIG. 22 shows a jBPM web front-end Task page, in accordance with an example embodiment;

FIG. 23 shows a UI associated with jBPM deployment within JBoss® Integrated Development Environment (IDE), in accordance with an example embodiment;

FIG. 24 is a diagrammatic representation of a machine in the example form of a computer system within which a set of instructions, for causing the machine to perform any one or more of the methodologies discussed herein, may be executed.

### DETAILED DESCRIPTION

Some of the embodiments described herein may be utilized advantageously in the field of light-weight business process composition as an implementation of techniques for end-user-driven Business Process Management (BPM). End-user-driven BPM is a technique to permit business users, who hold the actual knowledge of business processes, to actively participate in design and adaptation of business processes without requiring advanced technical expertise or process modeling capabilities. Example framework, which is discussed in more detail further below, may be adapted to consider the specific areas of expertise of various stakeholders involved in business process modeling. For example, business users are typically responsible for executing the processes, process designers (consultants) may be responsible for modeling the processes in order to optimize enterprise performance and increase productivity, while developers may be responsible for extending process models with rule sets and automated (e.g., computational) tasks and software artifacts, such as, e.g., event handlers, exception handlers etc. Some of the techniques described herein may be used to provide business users with a key role in the process composition and transferring adequately their process knowledge to the two latter parties—process designers and developers. The framework may permit business users to perform process designer tasks with minimal requirements for extension of their technical skills.

Some of the problems identified by the inventor are discussed below. Business users, who lack advanced technical expertise and process modeling skills, need to be involved in business process modeling and management. Enterprises are constantly struggling to optimize their business processes in order to gain competitive advantage in the dynamic market environment. The detailed process knowledge in enterprises is held by the end-users of enterprise software, who actually execute the business processes. While it may be beneficial to involve end-users in the overall process composition and management, such end-users (business users) may lack advanced technical expertise and process modeling skills. On the other hand, business users are accustomed to dealing primarily with office tools such as email applications and managing their daily tasks with to-do lists. Because such tools are far from any formal process modeling environment, it may be advantageous to utilize standard tools used by business users, such as email and to-do lists, to collect data for process modeling.

Process modeling efforts that utilize real life events relating to daily activities of business users (e.g., delegation of sub-tasks, email exchanges, and artifacts) may contribute to a more consistent and accurate reusable process description. Business processes are not static and may change over time. Experts skilled in the area of business modeling may not be readily available may a need for modifying a process model arise. It thus may be advantageous to involve business users in activities aimed at further adaptation of the processes.

One example solution to the challenges in the area of business modeling discussed above may include creating a common representation of a business process, based on data, generated in the standard business user tools—email and to-do lists. This data may be translated into formal process models based on tracked change and reuse history of user-defined task hierarchies. The resulting formal process model entities may reference corresponding ad-hoc tasks defined by end-users. This approach may contribute to common process understanding and business user-driven process composition. In one example embodiment, the framework discussed herein may encompass the concepts outlined below.

A weakly structured, underspecified process definition may be generated by combining user defined task hierarchies, emerging in the standard user office tools, e.g., in the context of email and personal task management. This weakly structured representation may combine ad-hoc user-defined task hierarchies along with any used artifacts and human actors. A weakly structured representation may constitute Task Delegation Graphs (TDG).

Task changes for personal tasks of business users (e.g., changes in task attributes such as description, percent complete, as well as artifacts that are added, removed, or content-changed) may be tracked. The tracked task changes may be used to derive a task history for a given user-defined task on a central enterprise repository (e.g., a task-tracking repository). Ancestor/descendant relationships may be established during reuse of user-defined Task Patterns (TP). A task pattern may be is the form of a diagram representing a business process. A formal business process model definition may be derived in a semi-automated manner from the user-defined, ad-hoc task hierarchies (TDG) based on the captured task change history from the actual process execution.

Over time, an enterprise may recognize that certain processes occur repeatedly in the same or similar manner and may be standardized in a more formal manner than an ad-hoc TDG. Such processes may be described as formal process models (workflows), which can be further extended with automated rule-sets and computational procedures and executed on a given workflow engine. In one example embodiment, the framework described herein may permit definition of formal process models (WFs) from the user-defined ad-hoc task hierarchies (TDG). An example framework may thus be used to elicit structured formal process models from user-defined data in order to represent actual business processes without the need for laborious process analysis and process mining of data that may be dispersed in personal email and file folders. Resulting formal models may comply with various formal process modeling notations.

A formal business process model definition may be based on the task change history of ancestor and descendant tasks executed after reuse of a TP. Mappings from ad-hoc task hierarchy to a formal process model may be performed based on a predetermined mapping scheme. One example mapping scheme, mapping ad-hoc entities to generic WF entities, is based on the Business Process Modeling Notation (BPMN) notation defined by OMG (Object Management Group, which is a consortium focused on modeling and model-based standards) and is described further below.

In one embodiment, mappings may be provided accompanied by a comprehensive textual description (e.g., in HyperText Markup Language (HTML) format), clarifying reasons for creating the specific formal process model from the ad-hoc tasks. This description may contain links to the originating ad-hoc tasks and may be mapped to the resulting formal process model entities. The description may contain also links to the task change history entries, supporting the selected mapping scheme. One purpose of the description is to provide an explanation to end-users without technical and process modeling expertise regarding the reasons for generating a specific formal process model. The users can then read the explanation and determine whether the generated structure matches their intention and adapt the model if inconsistencies are found or extend it with additional process entities. Process entities, resulting from the ad-hoc, user-defined tasks, may preserve a reference to these tasks in order to preserve the original ad-hoc process data associated with the resulting formal process definition.

Formal process entities may be extensible by process experts or developers utilizing an appropriate formal process modeling notation. All user-defined, ad-hoc tasks with their overall TDG, message flow (e.g., emails), change history, ancestor and descendant hierarchies, as well as the explanatory description for the performed mappings (e.g., ad-hoc to formal model) may be available to the model editors and may provide a wide reasoning context for the process definition. Formal process definitions may be deployable on a selected workflow engine.

In some embodiments, process models may be stored as files or archives (sets of files), and may contain data required for the selected process modeling notation and any additional data for the referenced ad-hoc tasks. Such files can be exchanged between different users, e.g., experts for different facets of a given business process. Each user may be able to restore the complete generated business process model and the respective original ad-hoc task hierarchies from the process definition file(s). Users may be permitted to further extend or adapt the model, save the extended model into process model file(s) and forward them to other users. This approach may allow incremental modeling by different users. The file format can be, e.g., Extensible Markup Language (XML).

In one example embodiment, process models may be published to a remote shared process model repository, where different users, experts on different facets of a business process can access and develop or update the process model according to their expertise. When generated process models are stored in a remote shared process model repository, process model history may also be kept on the server in order to allow comparison and reuse of different versions of the adapted process model.

Apart from extensions to the design of the generated process model, runtime extensions of a process model may also be effectuated. One embodiment of a runtime extension procedure may be described as follows. If deviations from the static formal process definition are desired, the workflow engine may allow breaking the execution of a given process entity (e.g., by suspending the execution) and creating an ad-hoc task for this entity in a user to-do list in the office environment (e.g., in the context of an email client). The suspended workflow entity may receive a reference to the replicated (tracked) ad-hoc task entity on the server in order to allow navigation (e.g., visual navigation) from the formal process diagram to the associated TDG. The generated ad-hoc task may inherit the reference to the original ad-hoc task, from which the suspended process entity was generated. The references to the original ad-hoc task may be utilized by a user to obtain the TP for the referenced task and to reuse and adapt it for an ad-hoc execution of the generated ad-hoc task. A reference to the suspended workflow may be kept in the generated ad-hoc task. If a task in the associated sub-hierarchy of the generated ad-hoc task is referred further in the suspended workflow, the user may be notified and provided with an option to switch back to the matching formal process entity in the workflow when the referred ad-hoc task is reached in the ad-hoc hierarchy.

In some embodiments, it may be possible to switch back to the original suspended workflow entity after all tasks in the generated ad-hoc task hierarchy have been processed, and to continue or terminate the workflow. After the workflow is completed, additional formal process structures may be generated from one or more ad-hoc task hierarchies for the occurred deviation(s) and to merge them to the original formal process model definition of the executed workflow. The model thus may grow with as data from additional user-defined ad-hoc task hierarchies is being added.

In one example embodiment, the presented framework for end-user-driven business process management may be utilized beneficially to obtain from business users task-related data that may form a basic diagram of a business process—a task pattern. Task-related data may be collected via a plug-in installed with an end-user office application, such as, e.g., an e-mail client application. A plug-in, that may be termed a tracker, may be configured to detect that a certain task (e.g., termed a main task) has been commenced, and start monitoring for any events related to the task and collecting data associated with such events. For example, a tracker may detect that one or more subtasks of the main task have been delegated to certain users and collect such delegation data. The tracker may also detect that certain subtasks are being executed in parallel, e.g., by monitoring the status of subtasks indicating the percent completed values or any changes in target end task dates. The main task data collected in this manner may be then processed to construct a weakly-structured process model—a task pattern that represents ad-hoc task hierarchies associated with the main task. Thus generated task patterns may be expressed by a task delegation graphs (TDGs), as described further below.

A stored task pattern may be used to suggest a proposed task execution sequence whenever a task similar to the main task is encountered. It will be noted that the term “main task” is used to merely designate any parent task in a task hierarchy. A reuse of a task pattern is referred to as an alternative application case of the task pattern. An alternative application case of the task pattern may be performed such that some deviations from the original task pattern may be permitted. For example, not all events of the original task pattern may be executed, or events not appearing in the original task pattern may be added. The history of all alternative application cases may be saved and then used to generate a formal workflow process, which may contribute to a greater degree of accuracy in estimating any future ad-hoc tasks that may be able to benefit from the application of thus generated formal workflow process model. The process model may then be refined and optimized through process experts and software developers.

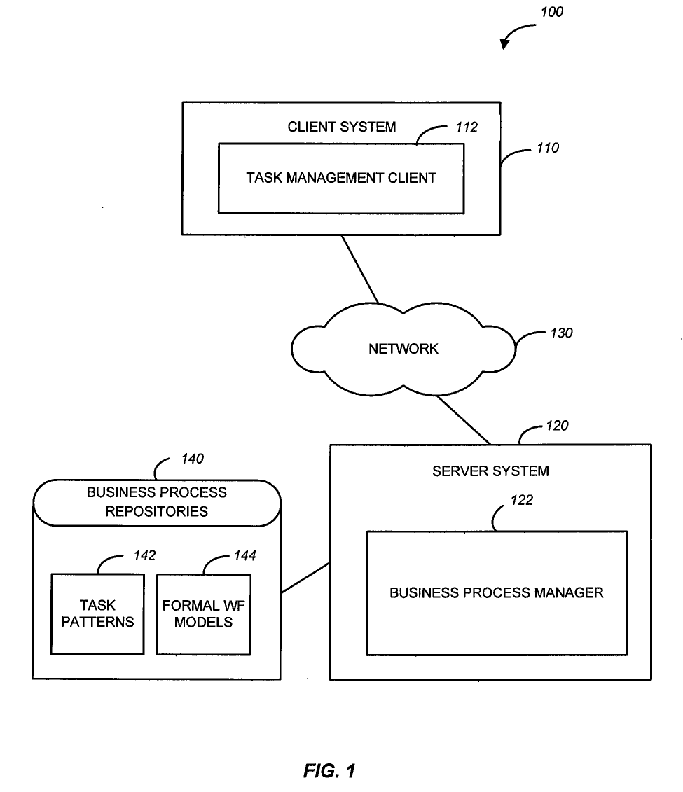

Example framework presented herewith may be extended beyond a simple process mining. The data for the derivation of the process structures may not only be captured from event logs and then evaluated through mathematical algorithms, but it may also be retrieved from weakly-structured Task Delegation Graphs (TDG) produced by end-users in the course of their every day work and may hold certain human-readable task information. A resulting process model may represent a formal model of a weakly-structured TDG. The task change history and task reuse history may be used during the process of model derivation in order to provide a human readable explanation of the resulting formal process model. Ad-hoc user tasks may thus be used to derive a formal structured process model, as well, as to provide an explanation of the generated process entities (e.g., utilizing a mapping scheme that provides associations between ad-hoc tasks and formal workflow model entities). The resulting model is understandable by the end-users and may be utilized by the end-users to determine whether the resulting structure matches the actual process they have executed. Users may be permitted to edit this explanation and change the matching structure. Example system for managing a business process may be described with reference to a network environment illustrated in FIG. 1.

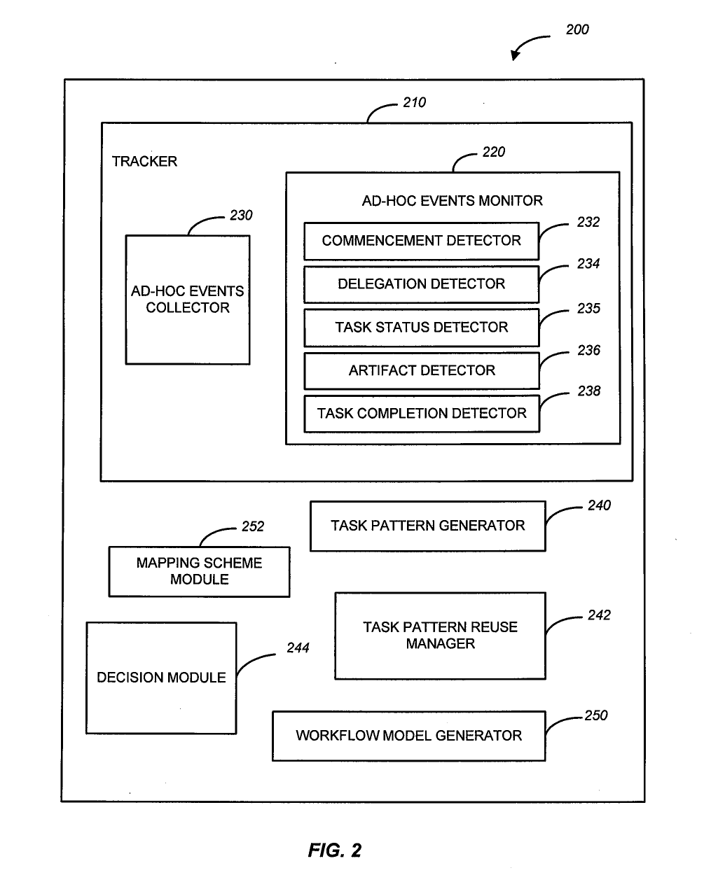

FIG. 1 shows an example network environment 100, within which method and system for aggregating risk in an enterprise strategy and performance management system may be implemented. The network environment 100 may include a client system 110 a server system 120. The client system 110 and the server system 120 may be in communications with each other via a network 130. The communications network 130 may be a public network (e.g., the Internet, a wireless network, a public switched telephone network (PSTN), etc.) or a private network (e.g., LAN, WAN, Intranet, etc.). The server system 120 may host a business process manager 122. The business process manager 122 may be in communication with business process repositories 140. The business process repositories 140 may include task patterns repository 142 and formal WF models repository 144. The client system 110 may host a task management client 112. The task management client 112, in some embodiments, may be implemented as an add-on to an email client application. The combination of some or all modules of the task management client 112 and some or all modules of the business process manager 122 may be referred to as a system for end-user-driven business process management. Example embodiment a system for end-user-driven business process management may be described with reference to FIG. 2.

FIG. 2 shows a block diagram illustrating an end-user-driven business process management system 200, according to one example embodiment. As shown in FIG. 2, the end-user-driven business process management system 200 comprises a tracker 210 that may be configured to monitor and collect events associated with ad-hoc tasks, a task pattern generator 240 to generate a task pattern based on the collected data, and a workflow model generator 250. The tracker 210 may include a monitor to monitor ad-hoc events associated with end-user task-management activities (an ad-hoc events monitor 220) and a collector to collect data associated with the ad-hoc events (an ad-hoc events collector 230). The ad-hoc events monitor 220 may comprise a number of detectors, each configured to detect certain task-related events. Example detectors include a commencement detector 232 configured to detect the commencement of a task, a delegation detector 234 configured to detect if a task has been delegated, a task status detector 235 configured to detect the status of a task (e.g., percent complete), an artifact detector 236 configured to detect artifacts associated with a task, and a task completion detector 238 configured to detect the completion of a task. As mentioned above, various ad-hoc events collected by the system 200 may be assembled into a task pattern (TP). This may be performed by the task pattern generator 240.

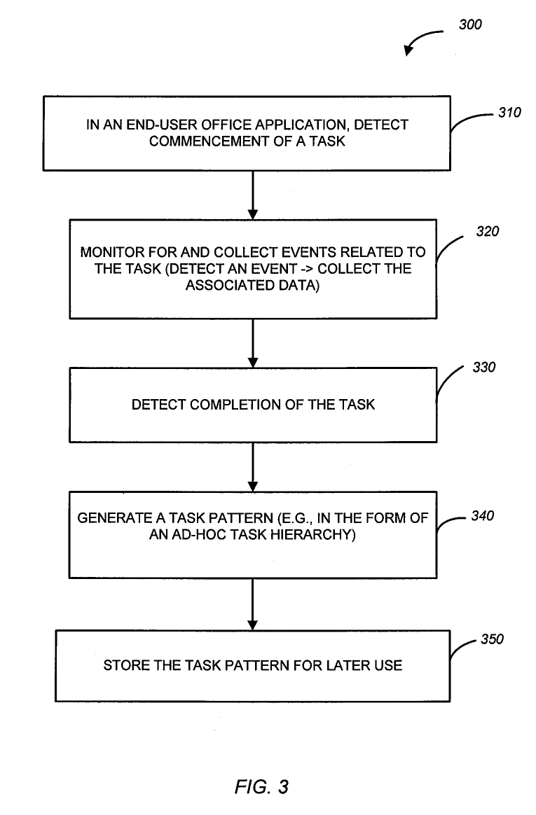

Generated task patterns may be stored for future reuse, e.g., in the task patterns repository 142 of FIG. 1. The task pattern reuse manager 242 may be configured to execute the task pattern and to store execution history of the task pattern. The system 200, as shown in FIG. 2, includes a decision module 244. The decision module 244 may be configured to determine whether a task pattern is to be converted into a formal workflow model. The workflow model generator 250 may be configured to generate a formal workflow model based on the task pattern and the execution history of the task pattern. Operations performed by the end-user-driven business process management system 200 in order to generate a task pattern may be discussed with reference to FIG. 3.

FIG. 3 is a flow chart illustrating a method 300 for generating a task pattern based on ad-hoc end-user activities, in accordance with an example embodiment. The method 300 may be performed by processing logic that may comprise hardware (e.g., dedicated logic, programmable logic, microcode, etc.), software (such as run on a general purpose computer system or a dedicated machine), or a combination of both. The processing logic, according to example embodiments, may reside in any of the modules shown in FIG. 2.

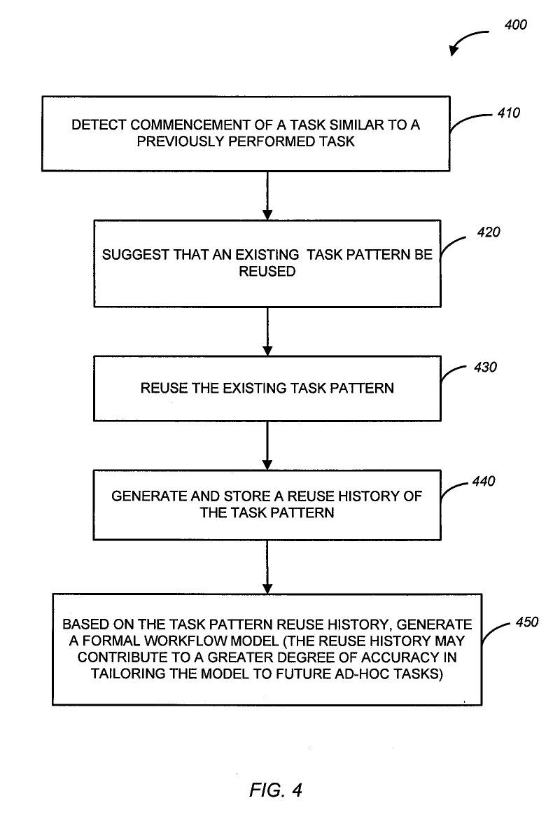

As shown in FIG. 3, the method 300 commences at operation 310, where the commencement detector 232 detects that a task has been commenced. At operation 320, the ad-hoc events monitor 220 and the ad-hoc events collector 230 cooperate to monitor for and collect events related to the task. When the task completion detector 238 determines, at operation 330, that the task has been completed, the task pattern generator 240 may be invoked to generate a task pattern (e.g., in the form of an ad-hoc task pattern hierarchy) at operation 340. The generated task pattern is stored in the task patterns repository 142 at operation 350. Operations performed by the end-user-driven business process management system 200 in order to generate a formal workflow model based on a task pattern may be discussed with reference to FIG. 4.

FIG. 4 is a flow chart illustrating a method 400 for generating formal workflow model based on a task pattern, in accordance with an example embodiment. The method 400 may be performed by processing logic that may comprise hardware (e.g., dedicated logic, programmable logic, microcode, etc.), software (such as run on a general purpose computer system or a dedicated machine), or a combination of both. The processing logic, according to example embodiments, may reside in any of the modules shown in FIG. 2.

As shown in FIG. 4, the method 400 commences at operation 410, where the commencement detector 232 detects that a task that is similar to a previously executed task has been commenced. At operation 420, the task pattern reuse manager 242 may determine that a task pattern associated with the previously executed task exists and generate a suggestion that the task pattern is reused for the similar task. The task pattern is reused at operation 430. At operation 440, the task pattern reuse manager 242 generates and stores a reuse history of the task pattern, e.g., in the task patterns repository 142. Based on the task pattern reuse history, the workflow model generator 250 generates a formal workflow model at operation 450. In one example embodiment, the workflow model generator 250 utilizes the mapping scheme maintained by the mapping scheme module 252 that may be based on the BPMN notation defined by OMG.

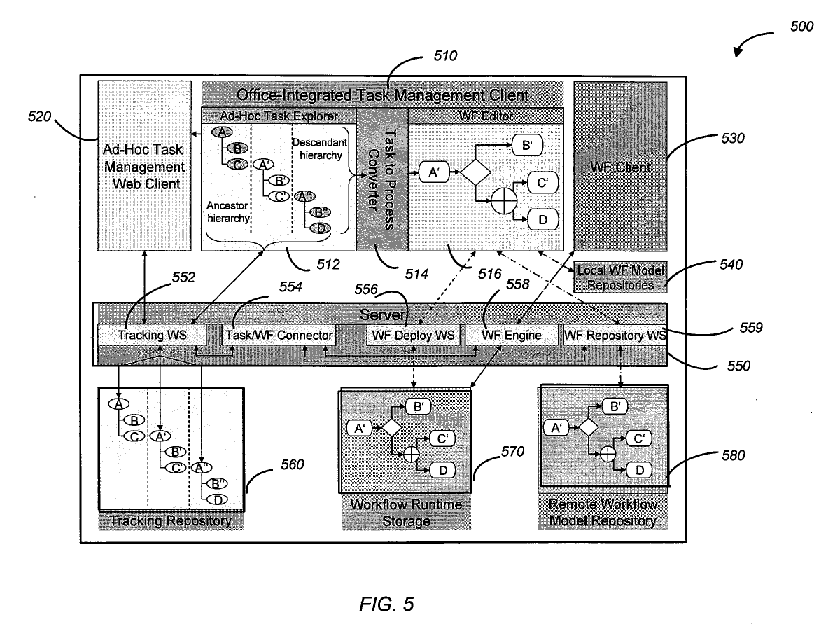

Example framework for end-user-driven business process management is described in further detail below. FIG. 5 is a diagrammatic representation of a framework architecture 500. The framework architecture 500, in one example embodiment, is organized in eight main blocks: an Office-Integrated Task Management Client (OITMC) 510, an Ad-Hoc Task Management Web Client (TMWC) 520, a Workflow (WF) Client (WFC) 530, a Local WF Model Repositories (LWFMR) 540, a server (middleware) 550, a Tracking Repository 560, a WF Runtime Storage (WFRTS) 570 and a Remote Workflow Model Repository (RWFMR) 580.

The OITMC 510, in one embodiment, may be integrated into a standard end-user office application, such as, for example, an email client, and may provide unobtrusive composition environment for the ad-hoc task hierarchies, e.g., by integrating email and personal to-do lists. The OITMC 510 can be implemented, for example, as an add-in application for an email client application, extending task lists to include hierarchical tree structure and to allow task delegation over email. The OITMC 510 may include components for ad-hoc task hierarchy representation and editing, such as, e.g., an Ad-Hoc Task Explorer 512 to navigate task hierarchies, a Task-to-Process Converter 514 to convert task hierarchies into formal process definitions, and a WF Editor 516 to permit editing of formal process models.

Ad-hoc task hierarchies can be generated through adding tasks and sub-tasks in a hierarchical to-do list utilizing an email client application. Such hierarchies can be further extracted and edited in the Ad-Hoc Tasks Explorer 512. In one embodiment, the Ad-Hoc Tasks Explorer 512 may be configured to also permit viewing of ancestor and descendant hierarchies of a main task and to restrict editing of the ancestors and descendants. In that embodiment, ancestors and descendants represent tracked tasks, which have been executed and are available as real-life task execution history rather than as adaptable task models.

The workflow editor may provide support for the selected formal process modeling notation. This component may further provide extended functionality for delivering appropriate explanations on the generated WF entities and to interlink those entities with the corresponding original ad-hoc tasks. The WF editor may integrate a representation of the ad-hoc task hierarchies, ad-hoc task evolution explorer (ancestor/descendant), ad-hoc task change history. It has to further provide representation of the resulting formal process in the selected notation with the appropriate editing functionality to extend the derived model, adapt it where needed and add business rules and computational procedures as appropriate. The WF editor may further allow opening of WF archives—local WF file(s) and remote WF models stored on the RWFMR, editing of these models and saving them back to their original or to different location (local file(s) or RWFMR). The WF editor may also allow exploration of the RWFMR and the change history of the stored remote WF models e.g., by showing submission comments for WF models and opening these for viewing or editing. The deployment of the WF models to the WF Runtime Storage (WFRS) may also be done from the WF editor.

The WF Editor 516 may be configured to provide support for the selected formal process modeling notation. This component may further provide extended functionality for delivering appropriate explanations on the generated WF entities and to interlink those entities with the corresponding original ad-hoc tasks. The WF editor 516 may integrate a representation of the ad-hoc task hierarchies, ad-hoc task evolution explorer (ancestor/descendant), ad-hoc task change history. It may further provide representation of the resulting formal process in the selected notation with the appropriate editing functionality to extend the derived model, adapt it where needed and add business rules and computational procedures as appropriate. The WF editor 516 may further allow opening of WF archives—local WF file(s) and remote WF models stored on the RWFMR 580, editing of these models and saving them back to their original or to different location (local file(s) or RWFMR 580). The WF editor 516 may also allow exploration of the RWFMR 580 and the change history of the stored remote WF models, e.g., by showing submission comments for WF models and opening these for viewing or editing. The deployment of the WF models to the WF Runtime Storage (WFRS) 570 may also be performed from the WF editor 516.

The TMWC 520, in one example embodiment, may be configured to provide navigation through emerging user defined Task Delegation Graphs (TDG) beyond the personal workspace. The WFC 530 may be configured as a client application to provide an interface that permits users to interact with a workflow management system, e.g. with a jBPM workflow engine. The WFC 530 may be web based and configured to accommodate the type of WF engine that executes the generated models.

Generated WF models may be exported as physical files, e.g., in XML format. The files may contain all WF model information by making it possible to construct the whole model and fetch all ad-hoc task data from the server when the files are opened. Ad-hoc task data may be also stored locally depending on the required ad-hoc task export, e.g., artifacts may be encoded locally in the XML files in base64 binary, full task hierarchies may be exported etc. The Local WF Repositories (LWFR) 540 may be organized as file system folders, storing one or more WF model files or as files, storing the description of one or more WF models.

The server component 550 serves as middleware and may be configured to contain modules that provide various services for a system to manage a business process. The server component 550, in one example embodiment, includes a Tracking Web Service (WS) 552, a Task/WF Connector 554, a WF Deploy WS 556, a WF Engine 559, and a WF Repository WS 559.

The Tracking Web Service (WS) 552 may be configured to track emergent tasks and ad-hoc task changes to the task Tracking Repository 560, to retrieve data associated with tracked tasks from the server and provides the input for the TMWC 520, and to retrieve tracked task hierarchies from the server 550 to the OITMC 510 along with their ancestor and descendant data and task change history. This data may be utilized for generating workflows from ad-hoc task hierarchies. Generated workflows may be deployed in the WFRTS 570 through the WF Deploy WS. This service can also deliver deployed and executed models to the client, if these need to be extended with ad-hoc tasks due to deviations in the WF.

The Task/WF Connector 554 may be configured to provide functionality for connecting the task Tracking WS 552 with the WF Engine 558 and with the WF Repository WS 559. This arrangement permits interconnections of task data (e.g., data from the Tracking Repository 560) and WF model data from process runtime (e.g., data from WF Runtime Storage 570) and Remote Workflow Model Repositories 580.

The WF Deploy WS 556 may be configured to provide functionality for deploying WF models to the server 550. WF models may be deployed on the Workflow Runtime Storage 570, from where the process data is accessible by the WF engine 558, which is responsible for executing the respective WFs. This service may further be configured to retrieve WF models of executed processes, enriched with the execution data, and provide the WF models to the WF Editor 516. This approach may be beneficial where WF entities (tasks) have been suspended and transferred to ad-hoc tasks during process execution due to deviations from the prescribed flow. The respective extension tasks can then be retrieved utilizing the Tracking WS 552 in order to complement the WF model on-demand.

The WF Engine 558, in one embodiment, provides runtime environment for the generated WF. The provided runtime environment may be dependent on the selected process modeling notation. In order to permit suspension of WF tasks and switching into ad-hoc tasks, the WF Engine 558 may communicate with the Task/WF Connector 554 and therewith, with the task Tracking service 552, which can generate ad-hoc tasks on-demand and send an ID for referencing those tasks to the WF runtime engine.

The WF Repository WS 559, in one example embodiment, may be configured to submit generated process models to the Remote WF Model Repository 580 and to retrieve submitted models and deliver them to the client. The WF Repository WS 559 may be configured to communicate with the Task WF/Connector Service 554 to allow navigation to referenced ad-hoc tasks in WF nodes. For example, referenced tasks may be read out from the Tracking Repository 560 via the Tracking WS 552, such that the associated TDGs are displayed in the TMWC 520.

A deployed WF can be started in the WF Client 530 and executed by the WF Engine service 558. WF Engine 558 may be configured to be in communication with the Task/WF Connector service 554, which, in turn may be configured to communicate with the Tracking WS 552. The WF Engine 558 may thus have a connection with the Tracking WS 552. This connection may be utilized beneficially when a workflow entity (e.g., a task) is suspended and an associated ad-hoc task is being created. The Tracking WS 552, in one example embodiment, communicates with the WF Engine 558 via the Task/WF Connector 554 to detect whether a process that is currently suspended and executed via ad-hoc task hierarchy can be resumed in a process node with reference to an ancestor of a currently executed ad-hoc task.

The Tracking Repository 560, in one example embodiment, may store data associated with the tracked ad-hoc tasks. The WF Runtime Repository (WFRTR) 570 may be configured to store the deployed workflows and to provide and store the runtime data of the WF Engine 558. The Remote Workflow Model Repository 580, in one example embodiment, provides central shared-accessible storage of formal WF models.

The WF Runtime Storage 570 may be configured to store the deployed process models that are available for execution by the WF Engine 558. Any changes to the data of the running WF instances are also available in the WF Runtime Storage 570. The Remote WF Model Repository 580 (that may comprise multiple repositories), in one example embodiment, provide shared-accessible WF models, which can be viewed, edited and deployed according to a selected policy. The shared storage may facilitate the adaptation and reuse of WF models. WF model history functionality may also be provided in the Remote WF Model Repositories 580.

Ad-hoc task hierarchies may be used by end users to define ad-hoc weakly-structured process models. Such hierarchies may comprise personal tasks ordered in a hierarchical manner (e.g., where a task can have an arbitrary number of sub tasks) in individual to-do lists within the local workspace of a system user. Changes to local task hierarchies may be tracked on a central server (e.g., the server 550 of FIG. 5). Task delegation over email in collaborative processes may be tracked in order to integrate individual task hierarchies of different users into overall Task Delegation Graphs (TDGs). A TDG may represent user-defined human-centric enterprise processes. Emergent ad-hoc task hierarchies can be saved and reused as Task Patterns (TP). TP reuse may result in generating task-instance based ancestor/descendant references, which may be stored in the task Tracking Repository 560 of FIG. 5, along with the task change history. Task patterns may serve as a base for derivation of formal process models (also referred to as workflows).

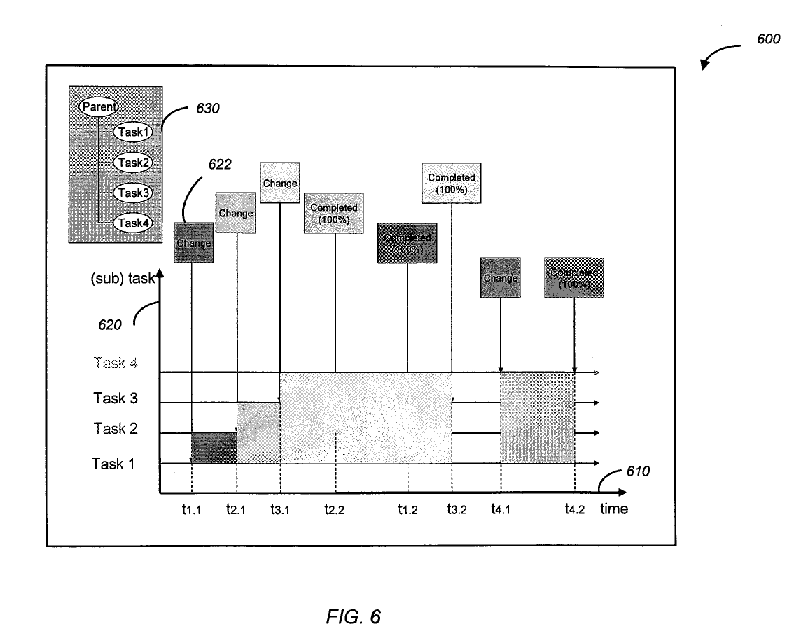

In deriving a formal process model based on a task pattern any available task change data may be utilized in order to determine the sequence flow or the order in which various tasks in the workflow are to be executed. The sequence flow may be determined, e.g., by examining task ranges of various tasks. A task range refers to the time, during which an ad-hoc task was executed (e.g., was being processed or acted on). A task range starts from the time when a first meaningful change referred to a Task Processing Change (TPC), indicating performance on a given task, is detected. A task range ends with the time when the task is completed. The range can be determined based on different criteria depending on what information is maintained for ad-hoc tasks. FIG. 6 shows how a task range is detected.

In FIG. 6, on the horizontal time axis 610, time increases from left to right. The vertical axis 620 contains different tasks (or subtasks), within the same parent task: Task1, Task2, Task3, and Task4. The associated task hierarchy is shown as element 630. At a given point in time (t1.1) the user performs a first TPC on Task1, which indicates an activity 622 on Task1. The criteria for a TPC, in one example embodiment, depends on what attributes are maintained for the task. Example attributes that may be maintained for a task (e.g., events associated with a task) may include increasing a ‘Percent Complete’ value that indicates the percentage complete for the task, updating artifacts contained in a task, or changing the task description by preserving the current text and adding additional comments. In some systems, where users are allowed to annotate tasks and the associated documents, a TPC may be noted when a task or associated document is changed or when a user explicitly annotates that they are acting on that task.

Although ‘start date’ and ‘due date’ may be maintained for an ad-hoc task, these dates are not necessarily considered actual task processing start or end times, as the actual work on the task may be executed independent from the designated ‘start date’ and ‘due date.’ Detecting whether a user is actually performing on a task based on some data as described above may be effected based on how users deal with ad-hoc tasks, e.g., whether they maintain the attributes regularly or whether they break down a high level task into meaningful sub tasks, which can be executed in parallel, or the results from which need to be merged at a later time. Therefore the presented framework does not need to rely on detecting the sequence flow, e.g., in what order the tasks were actually executed, with exact accuracy. In one example embodiment, the task change data is captured from the available system in order to provide a wide reasoning base and a possibly full explanation to the end user, as to why certain tasks are connected in a certain sequence in the generated formal model. The user may be permitted to change the generated model, e.g., if the assumptions made by the system are determined to be incorrect, and to change the explanation to motivate his changes and make them understandable for other users working on that formal process model.

As shown in FIG. 6, Task1 starts at t1.1 and ends at t1.2, Task2 is executed from t2.1 to t2.2, Task3 from t3.1 to t3.2, and Task4 from t4.1 to t4.2. All tasks can receive also further changes in their ranges. For example, Task1 can have other changes between the TPC in t1.1 and the completion in t1.2. As shown in FIG. 2, t1.1<t2.1 and t2.2<t1.2, which means that Task2 is fully executed within the range of Task1, e.g., Task1 and Task2 can be executed in parallel. As t1.1<t3.1<t1.2, Task3 can start before Task1 is ended, e.g., Task1, Task2, and Task3 can be executed in parallel. The range of Task4 does not overlap with any of the other task ranges. Therefore Task4 may be executed after all other tasks are accomplished.

The task ranges may be seen as a simplified way to suggest task sequencing. The sequencing of tasks may be based on assumptions, and a user performing model transformation from ad-hoc TDG to formal WF may be able to view the execution history and the accompanying task changes and TDG evolution and to estimate whether the suggested sequencing is correct. The sequencing of tasks can be improved, e.g., as a TDG is being reused multiple times through Task Pattern (TP) reuse. For example, more ancestors/descendants for a given task may become available. The task ranges from different executions (ancestors/descendants) can be compared in order to deliver task sequencing with higher certainty. For example, tasks with ranges that overlap in multiple independent ancestor/descendant executions can be considered parallel with a greater degree of certainty. A basic mapping scheme from ad-hoc task hierarchies to BPMN entities follows, which considers the task range detection, is described above.

Table 1 below provides example mappings of ad-hoc task hierarchies to formal process model entities based on the BPMN notation. Graphical representation of various BPMN elements may corresponds to those described and illustrated in OMG, 2006. It will be noted that ad hoc hierarchies may be represented graphically using a variety of graphical elements, such as, e.g., ovals, lines and arrows. Example ad hoc hierarchy and the corresponding formal workflow are illustrated in FIG. 5 within the OITMC block 510.

TABLE 1

| | BPMN |
|---|---|
| Ad-Hoc Task Elements | Elements Transformation |
| Events are not provided through the ad-hoc task | Event |
| hierarchies. Default Start and End events are added | |
| during process composition. These events can be | |
| adapted and further events can be generally added by | |
| key users, process experts and developers in the | |
| generated process model. | |
| Ad-hoc task without sub tasks may be represented by a single | Task (Atomic) |
| oval. | |
| Ad-hoc task with sub tasks may be represented by a tree | Sub Process |
| of ovals, as, e.g., shown in FIG. 1 within the Ad-Hoc | |
| Task Explorer 512 or within the Tracking Repository 560. | |
| Connections between a generated start event and the | Normal Flow |
| following ad-hoc task and between tasks and gateways | |
| (e.g., fork, join, etc.) may be made with normal flow. | |
| Ad-hoc (sub) tasks, which have sequential ranges and | Uncontrolled flow |
| are not executed in parallel but one after the other, may | |
| be connected through an uncontrolled flow. | |
| Conditional flows are not directly retrievable from the | Conditional flow |
| ad-hoc task data. Although certain text processing, e.g., | |
| of “if” and “when,” etc. statements within a textual task | |
| description, may imply certain conditions for an ad-hoc | |
| task. The default assumption is that conditional flows | |
| may be explicitly modeled by key users, process experts, | |
| or developers. | |
| Default flows are not directly retrievable from the ad- | Default flow |
| hoc task data. Although certain text processing, e.g., of | |
| “if,” “when,” etc. statements within a task description | |
| may imply certain conditions for an ad-hoc task, the | |
| default assumption is that default flows my be explicitly | |
| modeled by key users, process experts, or developers. | |
| Data about exceptional flows is not explicitly available | Exception Flow |
| in ad-hoc task hierarchies. Exceptional flows may be | |
| suggested during transformation and assessed and | |
| adapted by the users who perform the transformation. | |
| One possibility to suggest an exceptional flow is, e.g., if | |
| a task is inserted, executed, and completed in the | |
| hierarchy of parent task, after processing of the | |
| consequent sub tasks lower in the hierarchy has been | |
| started and before these were completed. For example, | |
| task E may be inserted between B and C, while task C is | |
| in progress. Task E would be executed and completed, | |
| before C has been completed. | |
| This could indicate that certain additional actions needed | |
| to be taken, which were not foreseen in the initial | |
| process execution. For example a sales employee has to | |
| update customer sales order data in a Customer | |
| Relationship Management (CRM) system (task C) but | |
| the transaction fails due to the system error. The sales | |
| employee may then create a task (task E) within the | |
| current sales order TDG hierarchy in order to correct the | |
| transaction error and to delegate task E to the IT | |
| department. The motivation thereby would be that the | |
| respective TDG will reveal the bottleneck in the process | |
| and the reason for eventual delays, e.g., why task C - | |
| e.g., the customer order update - is not processed yet. It | |
| will be visible that the process cannot go further until | |
| the issue is fixed. | |
| A recipient task from one pool and a requester task from | Message Flow |
| another pool, resulting from delegation of ad-hoc tasks | |
| may be associated with a message flow. As pools are | |
| not explicitly defined in ad-hoc task processing (as | |
| discussed below), tasks may be considered as residing in | |
| a different pool if, e.g., the user email address of the | |
| delegate has a different domain than the email address of | |
| the requester, or if the delegate does not have the system | |
| installed and only receives an outgoing task in the | |
| tracking repository without further task processing | |
| information, e.g., the latter user may be of different | |
| department or company. | |
| Compensation associations can be added for ad-hoc | Compensation |
| tasks, which include delegated sub tasks and have been | Association |
| cancelled. The default behavior for cancellation of | |
| delegated ad-hoc tasks is to send notifications to all | |
| recipients in the subsequent delegation hierarchy. | |
| Another possibility to suggest compensation tasks is if a | |
| task was cancelled and after the cancellation a new task | |
| was inserted in the parent task hierarchy after the | |
| cancelled task while the parent task is already in | |
| progress, e.g., task E is may be inserted after task B has | |
| been cancelled, while A, C and D are in progress. | |
| Artifacts in ad-hoc tasks may be assigned as data objects | Data Object |
| to the respective tasks. | |
| (Sub) Tasks with overlapping ranges (e.g., sub tasks that | Fork (AND-Split) |
| can be executed in parallel) may be defined in parallel | |
| sequences in a fork. | |
| For example, referring to FIG. 6, if Range 1.1 overlaps | |
| with range 1.2, then tasks 1.1 and 1.2 will be | |
| transformed into parallel BPMN tasks in a fork. | |
| A fork (AND-Split) for (sub) tasks with overlapping | Join (AND-Join) |
| ranges (e.g., sub tasks, which can be executed in | |
| parallel) where both sub tasks were set to completed | |
| (none of them was cancelled or deleted) before | |
| proceeding with the next task e.g., before making a Task | |
| Processing Change to the next task in the ad-hoc process | |
| (TDG), may be followed by a corresponding AND-Join. | |
| Decision nodes resulting from the ad-hoc task hierarchy | Decision, Branching |
| initially may require manual decision about further | Point; |
| process execution, as end users are not expected to | (OR-Split) |
| initially model business rules or decision parameters. | -> See next rows |
| The decision nodes in the generated diagram can be | |
| accordingly adapted by advanced (key) users, process | |
| experts, or developers, based on the data provided in the | |
| ad-hoc task hierarchies. | |
| 1. Ad-hoc task, which occurs in ancestor or descendant | Exclusive Decision, |
| hierarchy in place of other child task(s) of the given | Branching Point |
| parent task is considered alternative to the missing | Decision nodes |
| task(s). For example, ancestor task A contains sub tasks | resulting from the ad- |
| B and C, task A′ contains sub tasks B′ and C′, and | hoc task hierarchy |
| descendant task A″ contains sub tasks B″ and D -> D | may initially require |
| may be considered alternative for C. As the number of | manual decision |
| ancestors/descendants increase it may be easier to | about the further |
| determine whether D is always a replacement for C, | process execution as |
| because it may be determined how often these tasks | end users are not |
| appear simultaneously in the same parent task. | expected to initially |
| 2. If sub tasks of A are B, C and D and D′ were | model business rules |
| cancelled or deleted in the reuse within A′, while C′ was | or decision |
| performed, and C″ was cancelled or deleted in the reuse | parameters. The |
| within A″ while D″ was performed, it can be assumed | decision nodes in the |
| that D″ and C″ are alternatives. As the number of | generated diagram |
| ancestors/descendants increase it may be easier to | may be accordingly |
| determine whether D is always a replacement for C, | adapted on-demand |
| because it may be determined how often these tasks | by advanced (key) |
| appear simultaneously in the same parent task. | users, process experts |
| | or developers based |
| | on the data provided |
| | in the ad-hoc task |
| | hierarchies. |
| Sub tasks with overlapping ranges, which are | Inclusive Decision, |
| transformed to fork (AND-Split) can be adjusted by | Branching Point |
| advanced users, process experts or developers to | |
| inclusive decision branching points by adding | |
| appropriate conditions on-demand. | |
| Ad-hoc tasks with overlapping ranges, where the | Merging (OR-Join) |
| evaluation of ranges and task history shows that all other | |
| parallel tasks were cancelled or deleted after one task | |
| has been set to completed, may be exported to merging | |
| (or-join). The more an ad-hoc task hierarchy is reused, | |
| the more accurate will be the estimation of whether the | |
| completion of one task automatically makes the other | |
| parallel tasks redundant. | |
| Ad-Hoc task can be marked as recurring. For example, | Activity Looping |
| tasks maintained by an email client may be marked as | |
| recurring. Such tasks will be exported to looping activities. | |
| TDG do not contain explicit looping data for sequence | Sequence Flow |
| flows. The looping data may be defined explicitly by | Looping |
| process designers and experts on the generated model. | |
| Tasks that receive subtasks with variances in certain task | Multiple Instances |
| attributes, preserving all other attributes equal, can be | |
| exported as multiple instances of a task, where each | |
| instance may receive a different value for an entry | |
| parameter. For example, tasks with subject suffix | |
| variances and same description and attachments may be | |
| considered multiple instances of the same task. For | |
| example, a Chief Financial Officer may send to a sales | |
| employee a generic ad-hoc task: “Process customer | |
| orders for customers C1, C2, C3” with an attached order | |
| template document and a description of the procedure as | |
| task description attribute. The employee would create 3 | |
| sub tasks for this delegated task: “Process customer | |
| orders C1,” “Process customer orders C2,” and “Process | |
| customer orders C3” by preserving the template and task | |
| description in each task. In the transformation to BPMN, | |
| a multiple instance element will be suggested for the | |
| delegated task, whereas the user can set the varying | |
| parameters (here, a customer name). | |
| Ad-hoc tasks, which are sent to external parties, e.g., to | Process Break |
| users who do not have the system installed, will be | (something out of the |
| tracked on the server only as outgoing tasks, whereas no | control of the process |
| knowledge about the further processing of those tasks | makes the process |
| will be available in the system. Process Breaks can be | pause) |
| added for those tasks in the BPMN diagram. | |
| Ad-hoc tasks do not contain transaction attributes. | Transaction |
| Transactions may be explicitly modeled by key users, | |
| process experts, or developers where needed. | |
| Associations may be used to link artifacts to the | Association |
| resulting tasks. Ad-hoc task attachments may be | |
| themselves represented as BPMN data objects. | |
| The explanation for the performed mappings from ad- | Text Annotation |
| hoc task hierarchies to WF model entities can be | (attached |
| associated in the resulting model as text annotation. | with an Association) |
| The pool is not explicitly retrievable from ad-hoc task | Pool |
| hierarchies. The company or department of the users | |
| involved in a process may be considered as a pool. One | |
| possibility to detect and assign pools in the | |
| transformation of collaborative ad-hoc processes is if, | |
| e.g., the email address of a delegate has a different | |
| domain than the email address of a requester. The pool | |
| may be further defined explicitly after the model is derived. | |
| As lanes the ad-hoc tasks use human actor information. | Lanes |
| E.g., the lanes are assigned to the users, owner, and | |
| recipients of ad-hoc tasks. | |

In one example embodiment, the presented framework may be used by applications that capture end user process knowledge through tracking data related to personal task management and informal task exchange over email. The tracked data may be used to further formalize this process knowledge in standardized process modeling notations, which may allow execution of structured workflows through a workflow engine and the extension of those workflows with business rules and computational procedures. Through usage of such applications business users are empowered to provide data about task sequencing (TDG), used artifacts (e.g., documents), task participants, as well as further details regarding activities that are being executed, such as, e.g., task subject and description, start date, and due date. The tracked data emerges as part of daily activities of business users and does not require confronting business users with explicit upfront process description or modeling environments. The real-life data can be then used for generation of formal WFs for repeated processes, in situations where formalization is acceptable and desired to provide process optimization.

The generation of formal WF models from existing ad-hoc task hierarchies may be based on a predetermined mapping scheme. A formal WF model may be enhanced with textual explanation of the generated mappings, together with information regarding the used ad-hoc tasks and the resulting WF model entities. Such additional information provides a wide reasoning base, where end users, process designers, and developers can extend and adapt WF models by examining an overview of all available real-life data and ad-hoc task execution history. This approach may contribute to shortening of implementation time of workflow projects and to making such projects less error prone. Furthermore, business users may be able to develop simple WF models and to extend their skill set towards process modeling with minimal effort. WF process models may be generated to preserve their flexibility and allow exiting the process towards an ad-hoc task. This ad-hoc task can evolve further as a TDG. Based on some predetermined criteria, e.g., as a result of matching ad-hoc task reference in a generated WF task, the flow can be switched back from the TDG to the formal process definition. The respective WF model can be thereafter extended with the TDGs for occurred deviations.

Thus, in one example embodiment, the framework combines an approach for ad-hoc generation of weakly-structured, human-centric business processes, a transformation methodology from ad-hoc to formal process structures, and a method for extending generated formal process models with ad-hoc task hierarchies. Thereby it permits business users, who actually hold the detailed knowledge of business processes, to adequately participate in business process design and management. As explained above, ad-hoc task hierarchies may be generated in a standard end user office application, such as, e.g., the email client. Tracking of task changes in personal to-do list and of email exchange on task delegation is utilized to construct a TDG that represents ad-hoc human-centric business processes.

Ad-hoc task hierarchies may be transformed to formal WF models based on a mapping scheme. The generated WF entities preserve a reference to the originating ad-hoc tasks. The WF models can be saved along with the ad-hoc task data and exchanged between or accessed by different users (e.g., in the Remote WF Model Repositories 580 of FIG. 5), who can contribute and complement the process models. The workflows can be executed as a combination of static process flow and ad-hoc task flow (TDG) whereby specific entry points between both executions can be identified based on the stored data about the ad-hoc task entities, used as origins for the definition of the WF model entities. Combined process executions—WF and TDG—can be used to extend WF models for future executions with the respective WF extensions, generated from the extending TDG.

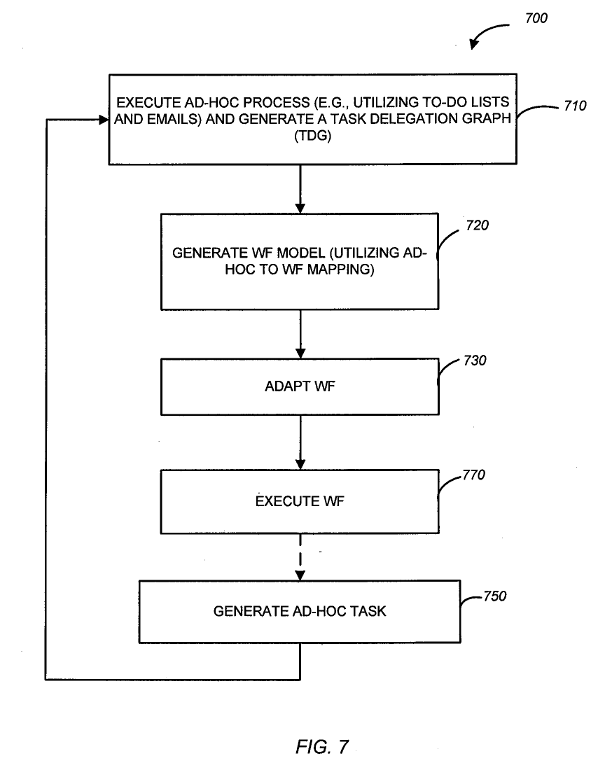

Example process flow may be described with reference to FIG. 7. As shown in FIG. 7, the usage process of the framework for managing a business process, in one example embodiment, may be viewed as comprising four main phases: execution of an ad-hoc process through using tasks in personal to-do lists and email for task delegation and subsequent generation of a TDG based on the tracked data (block 710); generation of a WF model from the ad-hoc process execution data based on a given mapping scheme (block 720); adaptation of the generated WF models, e.g., by adding parameters, conditions/rules and computational tasks (block 730); and deployment and execution of the WF models (block 770). In case of deviations where the provided WF structure is insufficient, ad-hoc tasks can be generated for WF tasks (block 750). The processing of these ad-hoc tasks generates TDG, which can be used to complement the generated WF model. This fifth step (block 750) is optional and applicable for cases where deviations from the generated WF structure are desired.

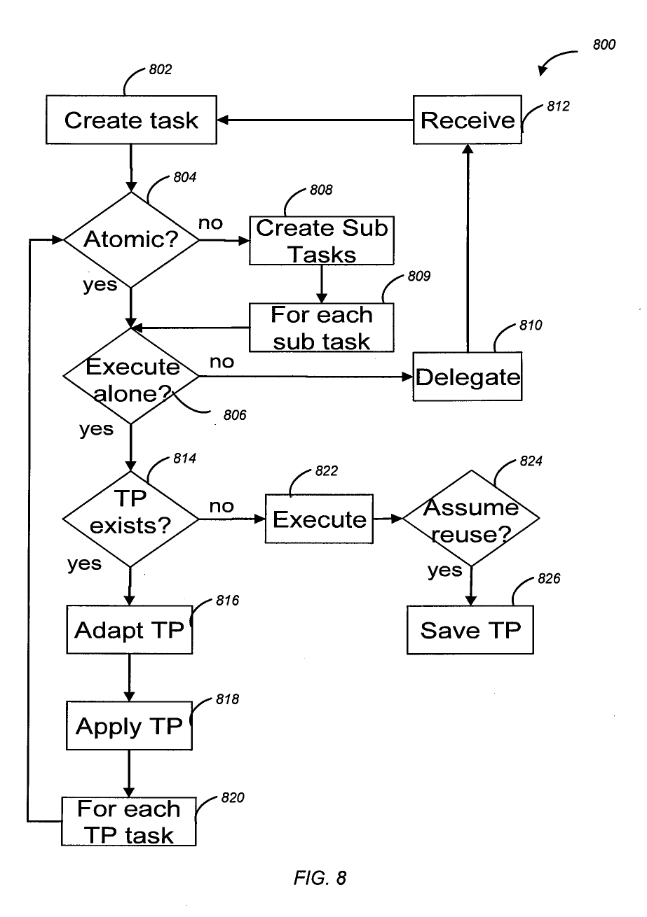

A detailed view of the first phase, generating of a TDG process flow, is shown in FIG. 8. The user creates a task in the to-do list (block 802). If it is determined at block 804 that the task is atomic, e.g., the block describes a self-contained activity that cannot be broken down into sub tasks, the user has to decide if they can execute the task themselves (block 806). If the task is not atomic, a break-down into sub tasks takes place (block 808) for each sub task (block 809).

For each of the sub tasks, the user has to decide (block 806) whether to execute them alone or to delegate them (block 810). If a task is delegated the recipient would create a copy of that task (block 812). When the user has to execute a task, the user first determines whether a Task Pattern (TP) exists (block 814) and whether it may be applied to that task. If a TP that can be applied to the task exists, so, the TP can be adapted for the current case (block 816) and applied (block 818). Thereafter the user can proceed with each task (block 820) from the applied TP as described above, e.g., estimate if it the next task is atomic or may be broken down further, if it may be delegated, etc. If it is determined, at block 814, that a TP that can be applied to the task does not exist, the task is executed (block 822) and if there is a possibility of reusing the task (block 824), the task is saved in a new task pattern (block 826). Tracking, in one example embodiment, takes place at task creation (including application of TP and generation of the contained TP tasks), at delegation, and at task execution. Task change history may be thus stored for each tracked event—creation, update, delegation, and deletion events.

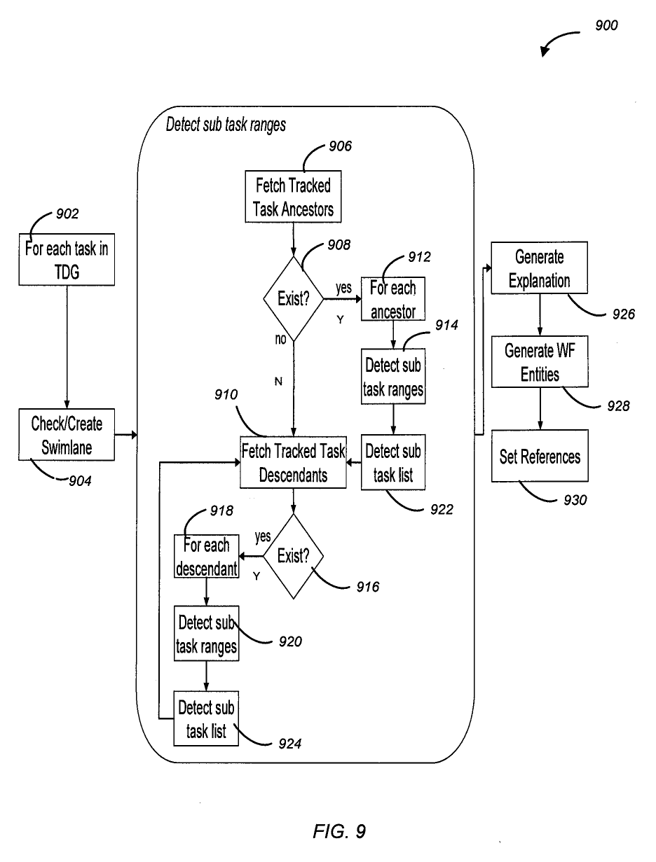

A detailed view of the second phase is shown in FIG. 9. FIG. 9 illustrates example WF generation process flow. As shown in FIG. 9, for each task from the TDG (block 902), a swimlane (e.g., a BPMN lane) is checked for existence based on the owner of the task. If none exists, a new swimlane is created and assigned to the user email address of the owner, so that the generated WF entities can be assigned to it. The next step is to detect the task sequence of the sub tasks. If no sub tasks exist, the ad-hoc task will generate an atomic (BPMN) task. If sub tasks exist, the sub task sequence is determined based on the ancestors and descendants of the task from the tracking repository. In one example embodiment, task execution history is kept only in the tracking repository 560 of FIG. 5. An attempt to generate a WF from a Task Pattern from a remote TP repository will result in an attempt to get an executed instance of the TP from the task tracking repository 560. All ancestors and all descendants of the given task are fetched iteratively (blocks 906 and 910) along the ancestor/descendant hierarchies from the tracking repository 560. The ranges of all sub tasks of the currently processed task in all found ancestor and descendant nodes are determined (blocks 912-920), based on the tracked task execution history for the sub tasks. The lists with sub tasks of ancestors and descendants are also determined (blocks 922 and 924) to detect available and missing sub tasks in the different executions, which are needed, e.g., for the exclusive decision nodes. Based on the found ranges and sub tasks availability, an explanation for the performed mapping is generated (block 926). Then, the actual WF entities are generated (block 928) and, finally, all references are set (block 930). The generated entities, in one example embodiment, refer to originating ad-hoc tasks and vice versa. Visual elements in the model graph may receive references to originating ad-hoc tasks and to resulting WF data nodes (objects). The explanation text for the performed mappings may be referenced from all instances, resulting from that mapping and kept for future reference.

The third phase of the example process flow illustrated in FIG. 7—WF model adaptation—may be performed manually, based on the provided ancestor/descendant evolution trees, task change history, explanation text and generated visual WF entities. The graphical WF editor environment (e.g., associated with the WF editor 516 of FIG. 5) may allow the user to change the flow, insert different element or remove generated entities, and to change the explanation text to match the final model transformation.

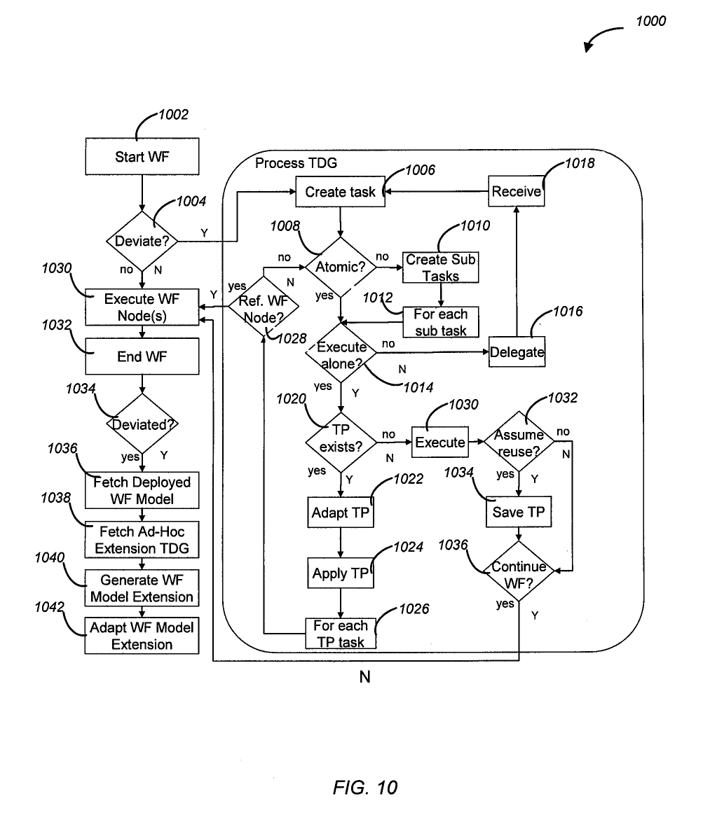

The fourth phase of the example process flow illustrated in FIG. 7—WF execution—is shown in more detail in FIG. 10. The generated WF model can be executed through the WF runtime. At block 1002, WF is initiated from the WF client 530 of FIG. 5. If the user chooses to deviate at a certain point due to rigidity of the provided WF model (determined at block 1004), an ad-hoc task can be created (block 1006), which is processed (blocks 1008-1036) as discussed above as well as with reference to FIG. 8. An applied TP can contain a task that has an ancestor or a descendant, referenced in the executed WF (determined at block 1028). Such references are detected through the task Tracking Service 552 over the Task/WF Connector service 554 and the WF Engine 558, all of FIG. 5. If a task has an ancestor or a descendant, the user may receive notification and may be permitted to enter back the suspended WF in the WF node (block 1030) with the reference to the ancestor/descendant of the applied TP task. The assumption is made that as the WF was generated (partially) by the referenced ancestor, the data for the WF node where the process is entered back may be elaborated and available to some extent in the ad-hoc process (TDG) and can be entered (e.g., automatically or manually), as may be required in the resumed WF. The second opportunity to enter back the WF (block 1030) is when the TDG for the generated ad-hoc task is completed. When the WF ends (block 1032), the user may check if it has been deviated at some point (block 1034). If deviations are available, the user may fetch the deployed WF model of the executed WF (block 1036) through the WF Deploy WS (block 556 in FIG. 5) into the WF Editor (block 516 in FIG. 5). The user may further fetch the deviated Ad-Hoc Extension TDG (block 1038) for the deviation task. This may be accomplished through the Tracking WS (block 552 in FIG. 5). Finally, the executed WF Model (fetched in block 1036) can be redefined, by complementing it with the Ad-Hoc Extension tasks (fetched in block 1038) by converting them according to the mapping scheme discussed above (see Table 1 as well as FIG. 6). Finally, the complemented WF Model can be extended by process designers and developers with additional computational procedures according to the selected WF notation (block 1042). In one example embodiment this may be accomplished in the WF Editor (block 516 in FIG. 5).

### Example Implementation

In one exemplary embodiment, Microsoft® Outlook® may be utilized to serve as an office integration environment, JBoss® Java® application server as the middleware and JBoss® Business Process Management—jBPM as a process modeling notation. Although jBPM does not provide the BPMN elements as described in the above sections, the basic elements, such as start, end, task, fork, join, sub process are available as to exemplify the conversion from ad-hoc task hierarchies to formal process models. Furthermore, jBPM tasks can be extended with parameters, expressions, and handlers, which take effect when the process model is deployed and the WF is executed. The framework may be implemented in the CTM (Collaborative Task Manager) prototype, screenshots from which are added herewith to represent the supported concepts.

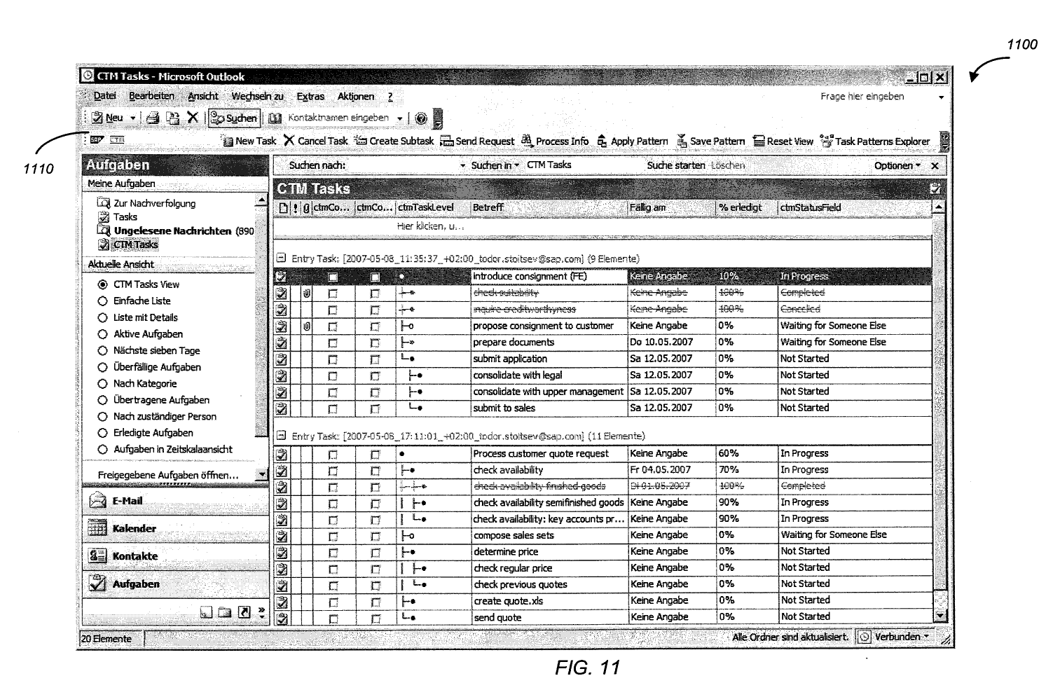

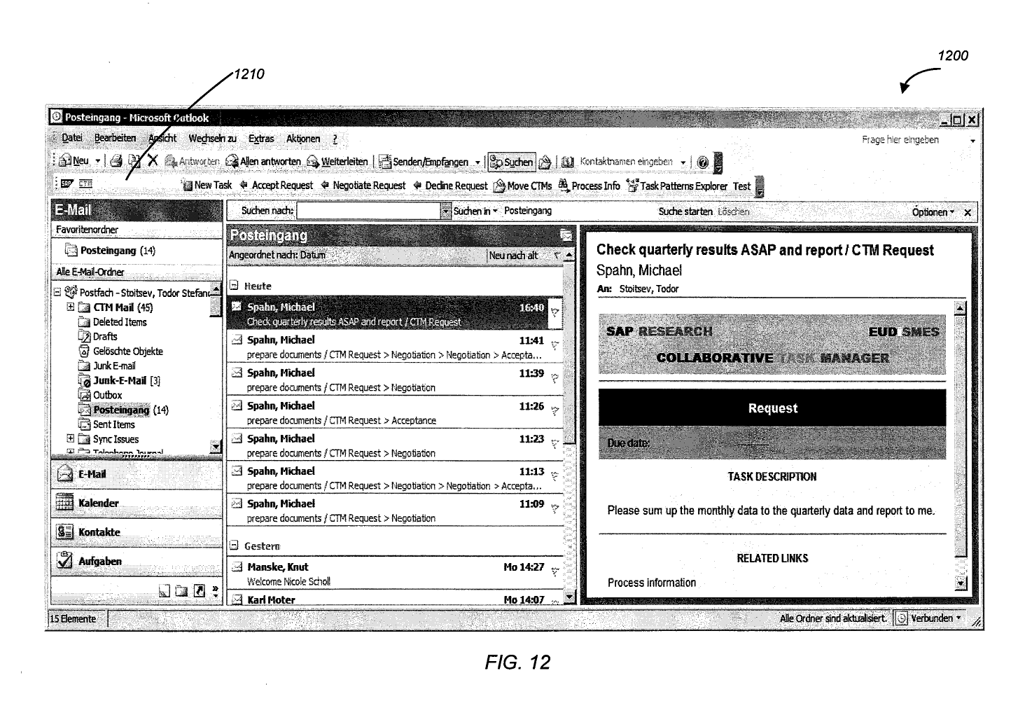

The OITMC 510 of FIG. 5 may be implemented as Microsoft® Outlook® Add-In application, which provides extensions to standard Outlook® email and task items to display a hierarchical to-do list and permit task delegation over email (CTM emails contain additional task metadata). Web services may be used to track the editing of tasks and the sending of emails through capturing outlook events with proprietary event handlers. An example user interface (UI) 1100 displaying CTM to-do list is shown in FIG. 11. As shown in FIG. 11, the UI 1100 includes a CTM toolbar 1110 that provides direct access to CTM functionality. FIG. 12 shows a UI 1200 displaying a CTM task request. As shown in FIG. 12, the UI 1200 includes a CTM toolbar 1210 that provides direct access to CTM functionality.

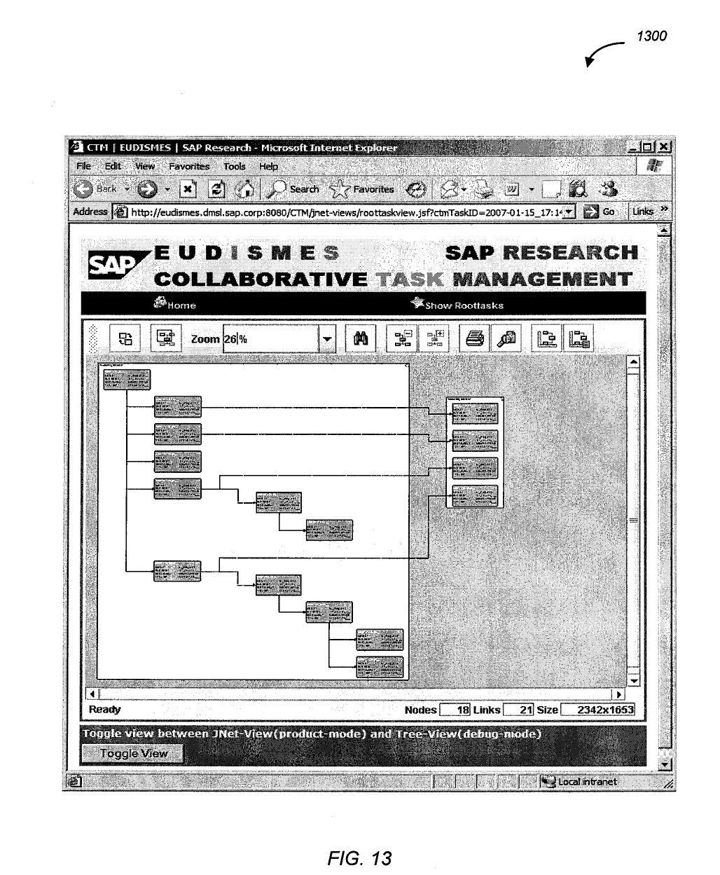

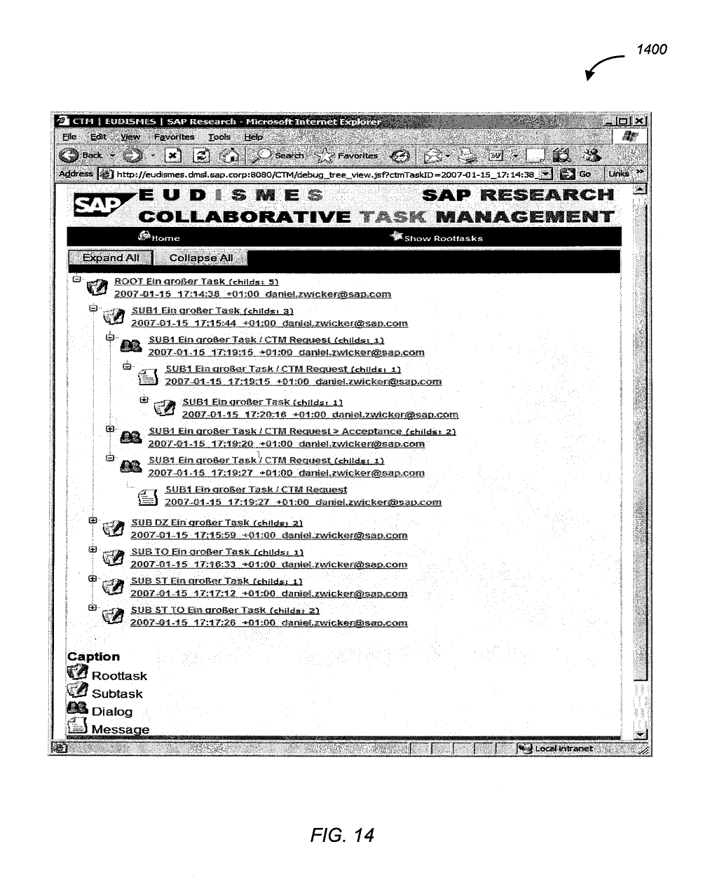

The task management web client (TMWC) 520 of FIG. 5 delivers TDG overview view over HTTP connection (optionally, over HTTPS). The task management web client may be implemented through a web application, which is deployed within the task management server application on the JBoss Java® application server. The task delegation graphs may be implemented in Java®, where nodes and edges are described as Java® classes. These classes add solution specific attributes and hence provide proprietary extension to a proprietary SAP® graphics framework called JNet, which creates the overall graph. The TMWC 520 may be deployed with the task management application called Ear (enterprise archive). The TMWC 520 uses Java® EJBs deployed with Ear to look up available tasks from a data storage. The looked up structures can be displayed via JNet, which provides the graph view in a Java® applet, as shown in FIG. 13. The view can be toggled to display tasks delegation tree structure, as shown in FIG. 14, through an Apache® MyFaces® Java® server faces functionality embedded in the TMWC 520. Views 1300 and 1400 from the TMWC 520 are shown in FIG. 13 and FIG. 14 respectively.

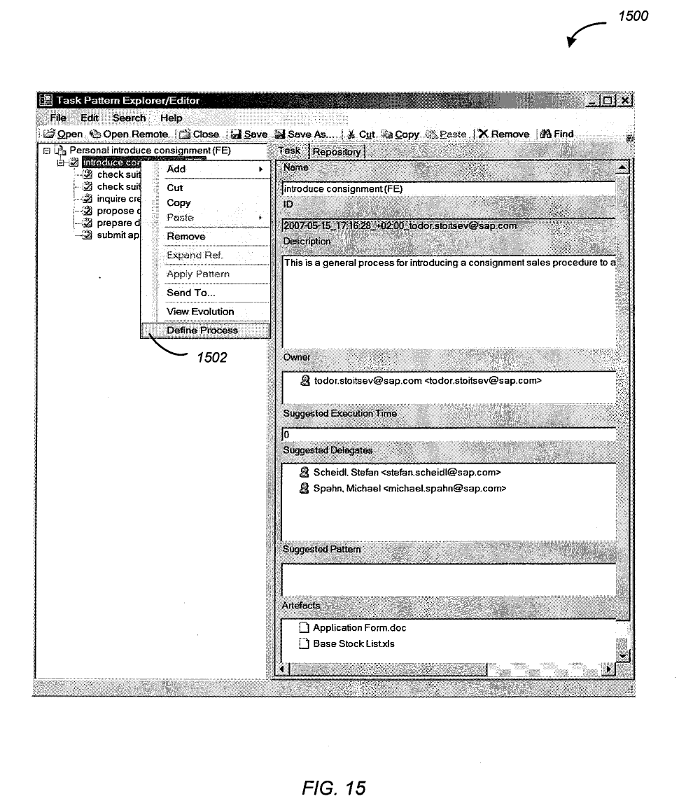

The Ad-Hoc Task Explorer 512 of FIG. 5, in one embodiment, allows saving and editing of TP, as well as selection and application of TP into CTM to-do lists. FIG. 15 shows an example UI 1500 of the Ad-Hoc Task Explorer 512. The example UI 1500 may be configured for displaying TP trees and for providing an entry point for process definition. For example, engaging a menu item 1502 titled “Define Process,” a user may call an arbitrary ad-hoc task and open the WF Editor 516.

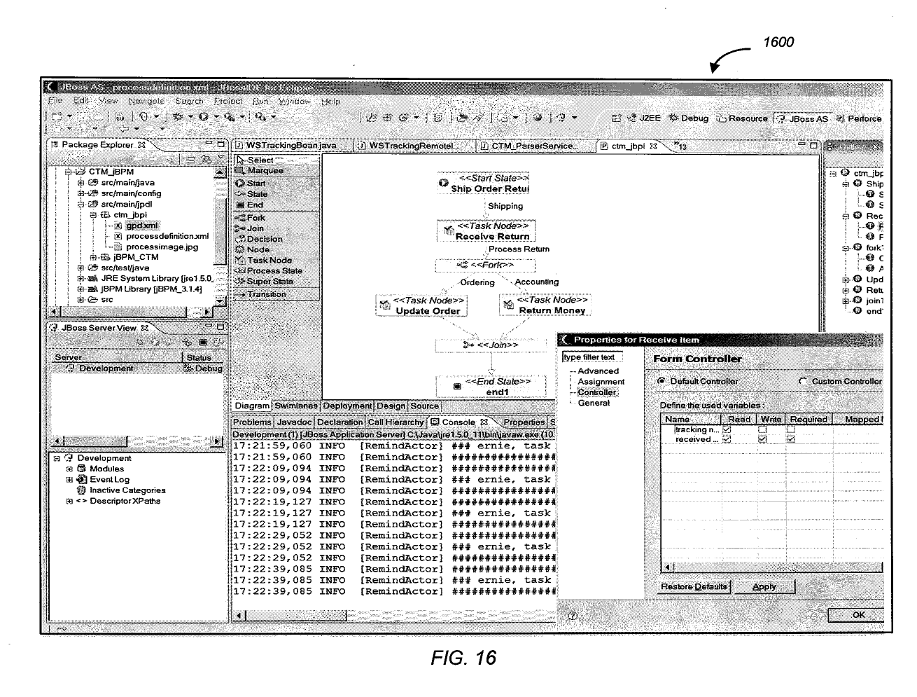

A brief overview of the jBPM process definition environment is discussed below. A jBPM process may be developed in the JBoss® Integrated Development Environment (IDE), which is an Eclipse® plug-in. FIG. 16 shows a UI 1600 of the jBPM process modeling environment. The basic elements correspond to BPMN notation entities as discussed above. Example mappings are provided in Table 2 below.

TABLE 2

| jBPM entity | BPMN entity |
|---|---|
| fork | Fork (AND-Split) |
| join | Join (AND-Join) |
| decision | Exclusive decision |
| | branching point |
| Task | Atomic Task |
| Process state | Sub process |
| Swimlane | Lane |

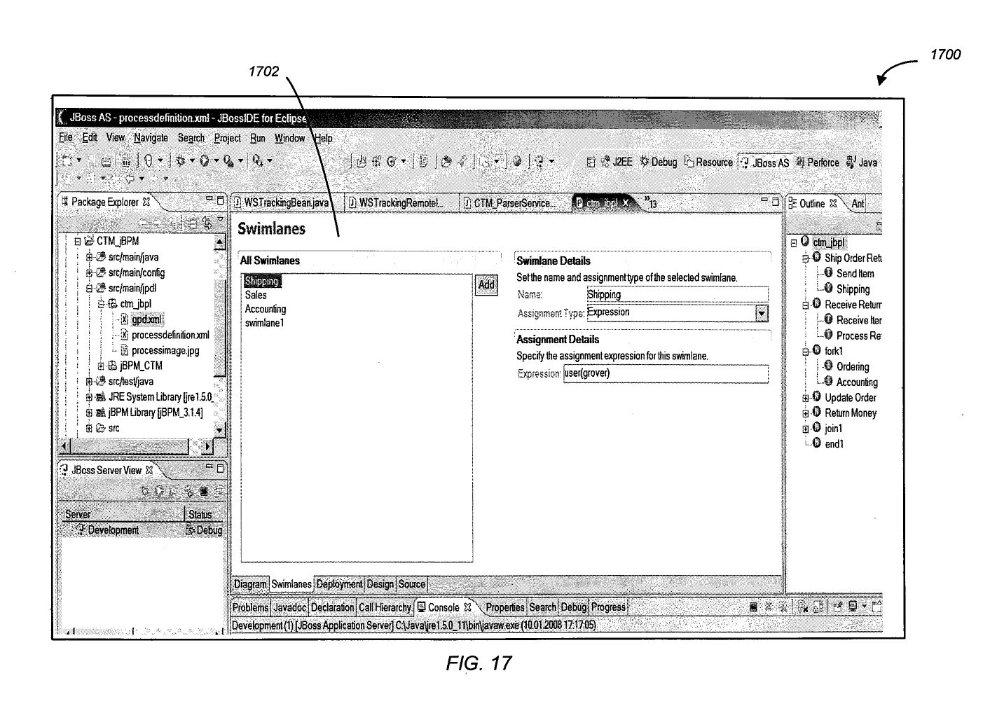

The CTM WF Editor 516 provides functionality displaying ad-hoc task hierarchies, which are used to design processes, as well as to view task evolution and task change history of executed ancestor/descendant entities, the generated process entities, the process diagram, and explanation text for the performed mappings. Swimlane assignments and the generated swimlanes are also shown and editable within the CTM WF Editor 516. The properties for the generated tasks can also be edited whereby execution variables and other parameters can be added to generated WF task instances. FIG. 17 shows an example UI 1700 that represents jBPM Process Definition Environment including Swimlanes. Swimlanes are shown in FIG. 17 in area 1702.

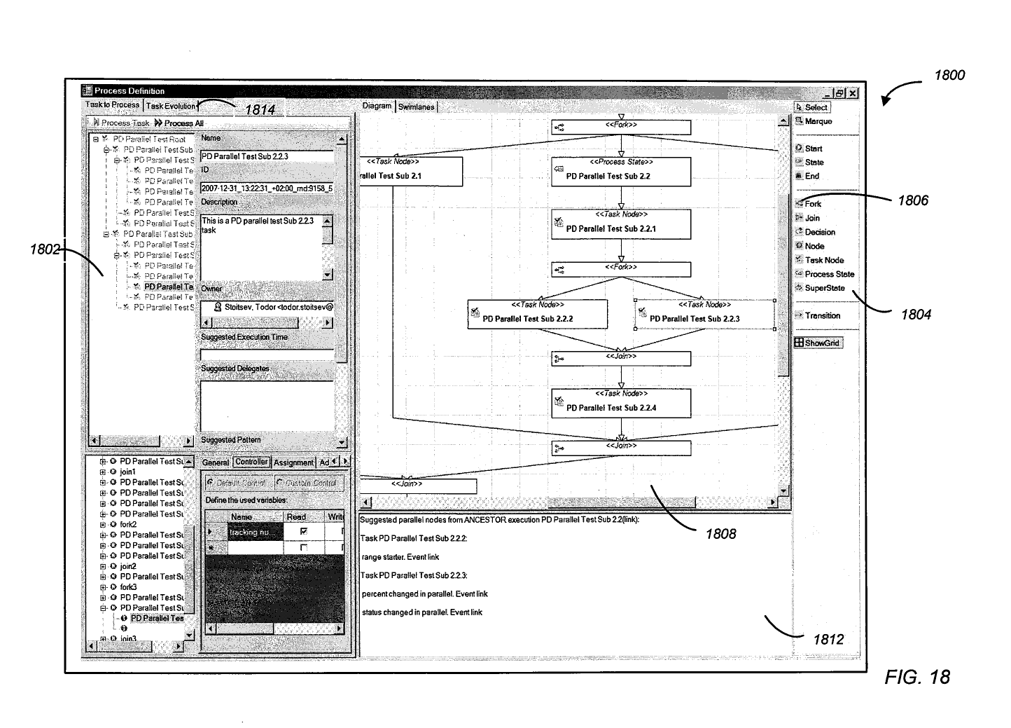

A screenshot from the CTM process composition environment including a UI 1800 is shown in FIG. 18. The tree view in area 1802 displays an ad-hoc task hierarchy used for the process composition. The property fields in area 1802 are the same as those in the UI 1500 associated with the Ad-Hoc Task Explorer shown in FIG. 15 (e.g., Name, ID, Description, Owner, Suggested Execution time, Suggested Delegates etc.), as the ad-hoc task for the process definition is imported from there. Ad-hoc task icons 1802 of already processed tasks in the ad-hoc task tree (block 1802) (i.e. tree node icons) are changed to the jBPM task icons. The generated process diagram is shown in area 1808. The corresponding jBPM process nodes are shown in the lower tree view in area 1802, whereby the properties can be extended according to the jBPM property set (see also FIG. 16). Key users, process experts, or developers may be permitted to define parameters and other options. Explanation text for the performed mappings is shown in area 1812 of FIG. 18. For the purposes of this description, the explanation text shown in the area 1812 is highly simplified. For example, “range starter” means that the task is the first task in the range and the reasons for the parallelism of the other tasks are listed further in the explanation text.

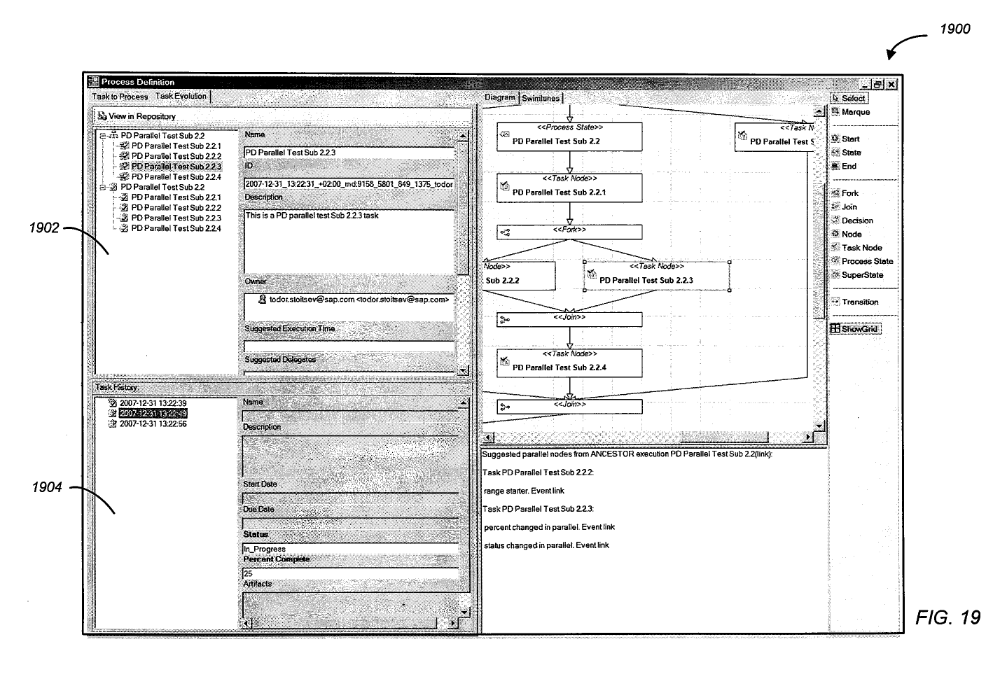

The jBPM entities in the generated structure shown in FIG. 18 were generated based on overlapping ranges where percent complete was changed in parallel. In this example, the percent complete change triggers also a status change; therefore a status change was also detected for the second task, which is indicated by the explanation in the area 1812 that reads “Task PD Parallel Test Sub 2.2.3.” Explanation text may be provided in HTML form, which is more interactive and may include different formatting. A click on the “Event link” text in the area 1812 may open the “Task Evolution” tab 1814. An example UI associated with the “Task Evolution” tab is shown in FIG. 19 which is addressed below. A user may select the appropriate change events for this explanation. Users may also be permitted to adapt the generated process diagram through the tools provided in the area 1804.

Appropriate jBPM tree node elements may be added in the jBPM tree view in the area 1802 for added elements in the diagram. Corresponding jBPM tree nodes for removed diagram elements will be deleted from the jBPM tree. Finally, an advanced navigation allows selecting the appropriate ad-hoc task node and jBPM process node when an element in the diagram is selected and vice versa. For example, selection of one of the entities (e.g., ad-hoc task, jBPM node, or element in the process diagram) selects the corresponding appropriate other elements and the corresponding explanation text for the elements is set if available.

FIG. 19 shows a UI 1900 associated with the tab with task evolution data. Ancestor node(s) with their child hierarchy are displayed in area 1902, above the currently handled task. The first ancestor is shown on top, subsequent ancestors follow; whereby the nearest (parent) ancestor of the task will immediately precede the handled task node. Descendants are displayed in the area 1902 under the currently processed node starting with the closest descendant. In FIG. 19, the task “PD Parallel Test Sub 2.2.3” is shown to have no descendants. The task change history for each ancestor/descendant node is displayed in the tree view in area 1904, where changed entries are displayed in property fields with white (active) background.

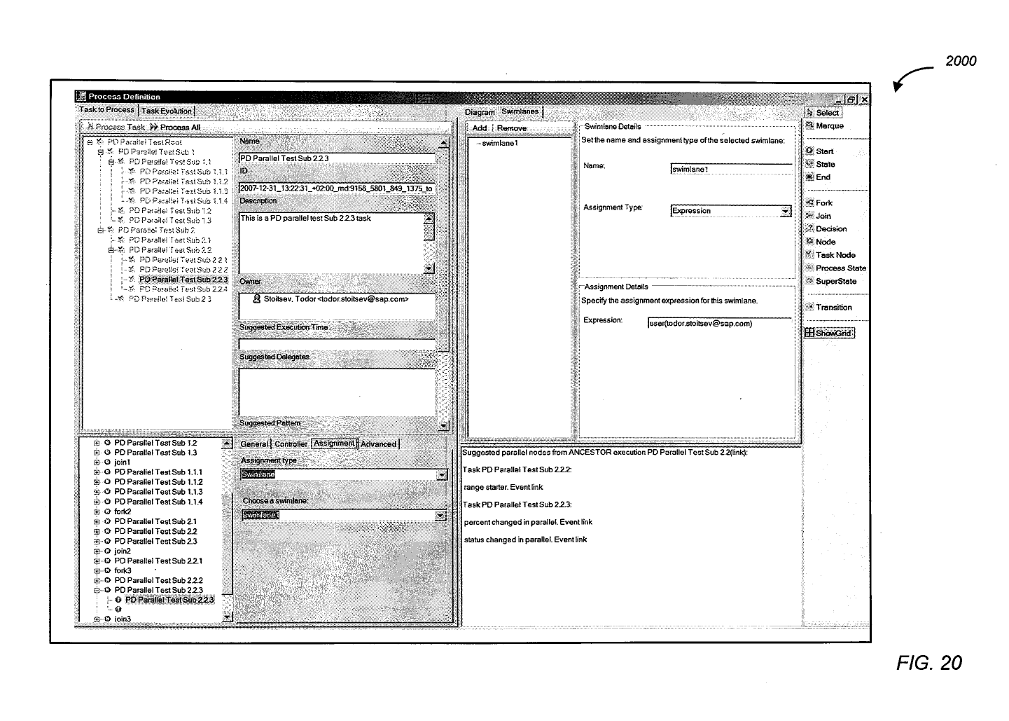

FIG. 20 shows a UI 2000 associated with the CTM process composition environment with the selected swimlane tab and the assignment property tab for the generated tasks. In one embodiment, swimlanes are created automatically for the generated WF entities based on the user data (owner) of ad-hoc tasks.

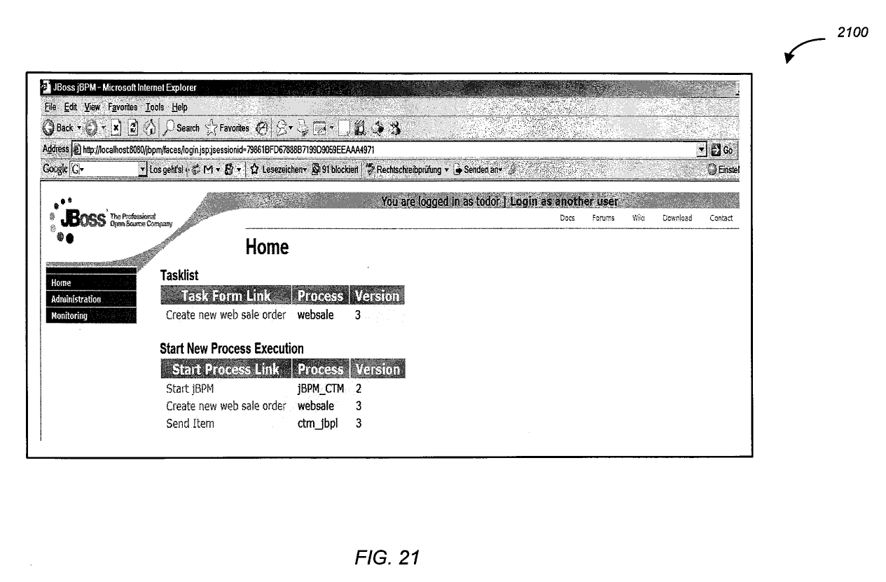

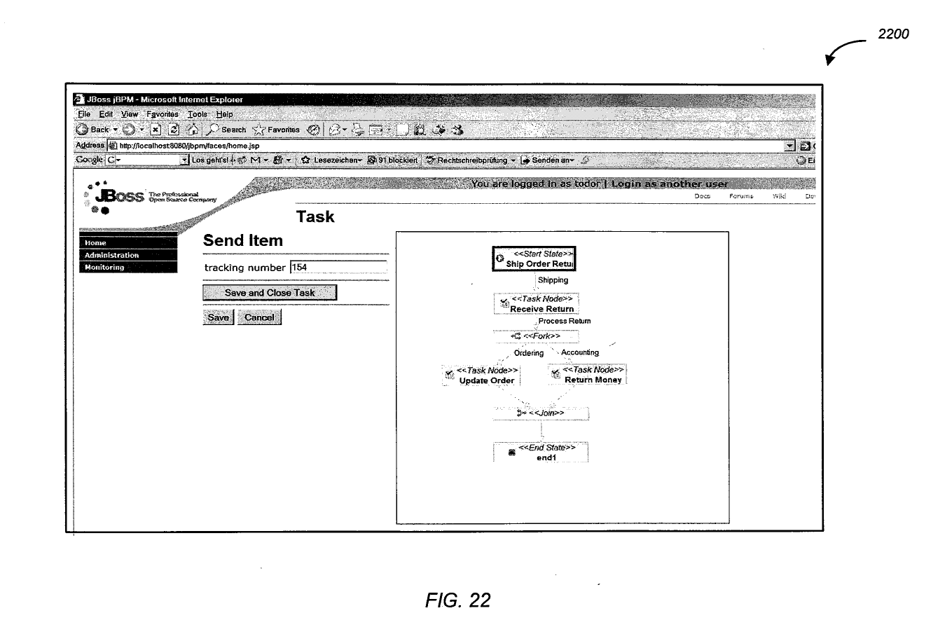

The workflow client 530 of FIG. 5, in one example embodiment, is provided through the standard jBPM front-end application (e.g., see JBoss®, 2007). Screenshots from the jBPM front-end are shown in FIGS. 21 and 22. FIG. 21 shows a UI 2100 associated with jBPM Web Front-End, where a user is provided with the view of all processes that can be initiated, as well as the current tasks. FIG. 22 shows a UI 2200 associated with jBPM Web Front-End, where a user is starting a new process and has to enter the required tracking number.

The export of generated WF model diagrams may be performed in the jBPM process definition format, e.g., in XML files that describe the process and the diagram, which may be extended with additional elements for referencing originating ad-hoc tasks and storing the explanation for the generated process entities. An example XML code is shown below. In the XML code, stored as processdefinition.xml, the jBPM task node receives additional CTM information, as indicated by elements <adHocTask> and <explanation>.

```
<task name=“Task PD Parallel Test Sub 2.2.3”>
  <controller>
    <variable name=“tracking number”
access=“read,write,required”></variable>
  </controller>
  <adHocTask>
      <taskId>2007-12-
30_15:14:12_+02:00_rnd:7696_3737_2569_9046_todor.stoitsev
@sap.com
      </taskId>
  </adHocTask>
  <explanation>
        <entry>
            <adHocTask>
                <taskId>2007-12-
30_15:14:12_+02:00_rnd:7696_3737_2569_9046_todor.stoitsev
@sap.com
                </taskId>
          </adHocTask>
      <text>
              <![CDATA[ Suggested parallel nodes from
ANCESTOR execution PD Parallel Test Sub 2.2:]]>
      </text>
    </entry>
    <entry>
          <adHocTask>
                  <taskId>2007-12-
31_13:22:17_+02:00_rnd:2352_7649_541_7973_todor.stoitsev
@sap.com
                  </taskId>
            </adHocTask>
            <taskChange type=“context_changed”>
                  <time>2007-12-31 13:22:46</time>
            </taskChange>
            <text>
              <![CDATA[range starter. Event link]]>
      </text>
        </entry>
        <entry>
            <adHocTask>
              <taskId>2007-12-
31_13:22:17_+02:00_rnd:2352_7649_541_7973_todor.stoitsev
@sap.com
              </taskId>
            </adHocTask>
            <taskChange type=“context_changed”>
              <time>2007-12-31 13:22:52</time>
            </taskChange>
            <text>
              <![CDATA[percent changed in parallel. Event link]]>
            </text>
          </entry>
          <entry>
            <adHocTask>
              <taskId>2007-12-
31_13:22:17_+02:00_rnd:2352_7649_541_7973_todor.stoitsev
@sap.com
              </taskId>
            </adHocTask>
            <taskChange type=“context_changed”>
            <time>2007-12-31 13:22:52</time>
              </taskChange>
        <text>
        <![CDATA[status changed in parallel. Event link]]>
      </text>
      </entry>
  </explanation>
</task>
```

The <adHocTask> element above only contains an id, which will permit obtaining the respective ad-hoc task and its full ancestor/descendant hierarchy from the tracking repository. An important note here is that the full task information may be included for offline usage e.g., in that case the <adHocTask> element will correspond to the “task” complex type in the TP XML schema format.

The <explanation> element given above contains the explanation for the performed ad-hoc to formal mappings. The explanation may be delivered in a single plain text (CDATA) element. A more complex notation is given above, where the explanation consists of multiple explanation entries to permit interactive navigation over included explanation data. First, the explanation may start with a set of entries, containing information about the data used for the respective transformation (WF generation)—these entries will present a list with the ancestor/descendant tasks used for the process model entities generation for the processed ad-hoc task. In the XML above only a single entry of this kind is provided with explanation text: “Suggested parallel nodes from ANCESTOR execution PD Parallel Test Sub 2.2:” as only one ancestor (execution sample) was available in the tracking repository for the processed task. The <adHocTask> element can, as described above, contain either only the ad-hoc task id or a full task representation. The following explanation entries contain information about the evaluated sub task sequencing, with <adHocTask> elements for the respective sub tasks, <taskChange> elements for the change events on which the mapping is based and a <text> element with readable description of the performed mapping. The <taskChange> element may contain only a <time> element, which together with the adHocTask id will permit obtaining the full task change information from the tracking repository. The <taskChange> element may also contain the full task change data, according to the task change XML schema complex types, which is provided below.

```
<complexType name=“taskChange”>
    <sequence>
      <element name=“time” type=“string”
maxOccurs=“1” minOccurs=“1”></element>
      <element name=“taskChangeData”
type=“tns:taskChangeData” maxOccurs=“1”
minOccurs=“1”></element>
    </sequence>
    <attribute name=“type” type=“string”></attribute>
  </complexType>
  <complexType name=“taskChangeData”>
    <sequence>
      <element name=“taskName” type=“string”
maxOccurs=“1” minOccurs=“0”></element>
      <element name=“taskDescription” type=“string”
maxOccurs=“1” minOccurs=“0”></element>
      <element name=“taskStartDate” type=“string”
maxOccurs=“1” minOccurs=“0”></element>
      <element name=“taskDueDate” type=“string”
maxOccurs=“1” minOccurs=“0”></element>
      <element name=“taskStatus” type=“string”
maxOccurs=“1” minOccurs=“0”></element>
      <element name=“taskPercentComplete”
type=“int” maxOccurs=“1” minOccurs=“0”></element>
      <element name=“artifactChanges”
type=“tns:artifactChanges” maxOccurs=“1”
minOccurs=“0”></element>
    </sequence>
  </complexType>
  <complexType name=“artifactChanges”>
    <sequence>
      <element name=“artifactChange”
type=“tns:artifactChange” maxOccurs=“unbounded”
minOccurs=“1” ></element>
    </sequence>
  </complexType>
  <complexType name=“artifactChange”>
    <sequence>
      <element name=“artifactId” type=“string”
maxOccurs=“1”
        minOccurs=“1”>
      </element>
      <element name=“artifactName” type=“string”
maxOccurs=“1”
        minOccurs=“0”>
      </element>
      <element name=“artifactChecksum”
type=“string” maxOccurs=“1”
        minOccurs=“0”>
      </element>
      <element name=“artifactLink” type=“string”
maxOccurs=“1” minOccurs=“0”></element>
  </sequence>
  <attribute name=“type” type=“string”></attribute>
    </complexType>
```

The jBPM process diagram—gpd.xml is exported based on the coordinates of the generated drawable process nodes in the WF Editor Visual Basic (VB) PictureBox. An example of the jBPM process diagram format is provided below.

```
<process-diagram name=“ctm_jbpl” width=“752”
height=“440”>
  <node name=“Ship Order Return” x=“174” y=“32”
width=“140” height=“40”>
    <transition name=“Shipping”>
      <label x=“5” y=“−10”/>
    </transition>
  </node>
  <node name=“Receive Return” x=“173” y=“117”
width=“151” height=“40”>
    <transition name=“Process Return”>
      <label x=“5” y=“−10”/>
    </transition>
  </node>
  <node name=“fork1” x=“171” y=“187” width=“153”
height=“25”>
    <transition name=“Ordering”>
      <label x=“5” y=“−10”/>
    </transition>
    <transition name=“Accounting”>
      <label x=“5” y=“−10”/>
    </transition>
  </node>
  <node name=“Update Order” x=“81” y=“251” width=“140”
height=“40”>
    <transition name=“”>
      <label x=“5” y=“−10”/>
    </transition>
  </node>
  <node name=“Return Money” x=“268” y=“250” width=“140”
height=“40”>
    <transition name=“”>
      <label x=“5” y=“−10”/>
    </transition>
  </node>
  <node name=“join1” x=“171” y=“331” width=“170”
height=“25”>
    <transition name=“”>
      <label x=“5” y=“−10”/>
    </transition>
  </node>
  <node name=“end1” x=“172” y=“396” width=“168”
height=“40”/>
  </process-diagram>
```

Finally, the processimage.jpg for the jBPM process definition is exported from the WF Editor picture in the picture box. These files can be used in a jBPM project in the JBoss® IDE (see FIG. 16) where developers can extend the process definition with handlers and classes for performing advanced exception and event handling, event triggering through timers etc.

The task management server application is a Java® enterprise application. It is packed in an .ear archive and deployed to a JBoss® Java® application server. The task management server application contains the web-module for the TMWC 520 of FIG. 5 and also enterprise Java® bean (EJB) components for the persistence of data in the data storages—Tracking Repository 560, WF Runtime Storage 570, and Remote WF Model Repository 580. The server application also contains the web service components, which are XML web services based on the Simple Object Access Protocol (SOAP) for the communication and on Enterprise Java® Beans (EJB) 3.0 and Remote Procedure Call (RPC) for the server implementation. The jBPM functionality is permitted through deployment of standard jBPM enterprise modules—jBPM.war (client) and jBPM.sar (service)—see (JBoss®, 2007).

The Tracking Service 552 of FIG. 5, in one embodiment, is implemented as Java® web service, deployed on the JBoss® Java® application server. From client side, VB .Net client proxy classes are generated based on the Web Service Definition Language (WSDL). The VB .Net clients communicate with the Tracking Service 552 to track captured Outlook® task and email events.

Task WS/Connector Service 554 of FIG. 5 may be implemented as a Java® service, deployed on the JBoss® application server. The WS/Connector Service 154 uses a connection to the local interfaces of the Tracking Service 552, WF Engine 558, and WF Repository Service 557 to permit their interconnection.

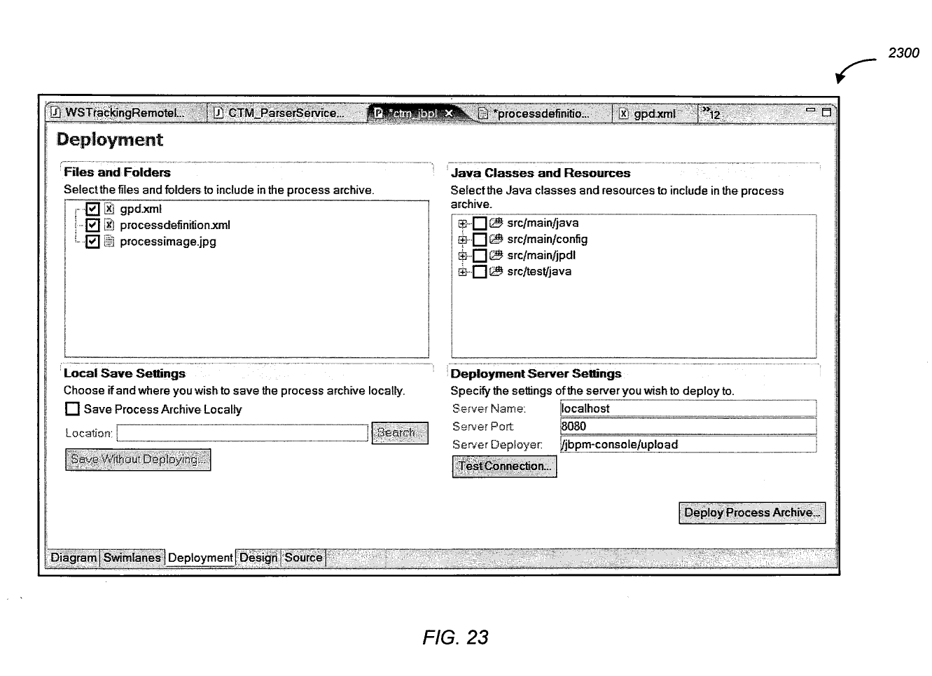

The WF Deploy WS 556 of FIG. 5 may be implemented as a Java® web application, deployed in a jBPM.war archive on the JBoss® application server. The WF Deploy WS 556 may be used over HTTP. An example implementation may be provided utilizing JBoss® jBPM framework as shown in FIG. 23. FIG. 23 shows a UI 1900 associated with JBoss® IDE—jBPM deployment, where the process archive is delivered to a predetermined location (e.g., http://localhost:8080/jbpm-console/upload).

The CTM integrated WF Editor may be configured to perform deployment over a web request to the target destination by archiving and sending the process archive. The extensions to the WF Deploy service may be provided for delivering back deployed process models for the extension with ad-hoc task hierarchies. On-demand deviations may be implemented either through extending the standard jBPM web application (JBoss® is open-source project) or developing a custom web service, which reads out the data from the jBPM Runtime Storage (e.g., a database) and sends the information back to the front end in the jBPM process format (XML) discussed above.

The WF Engine 558 of FIG. 5, in one example embodiment, is provided by the JBoss® jBPM framework in a standard jBPM.sar archive and deployed on the JBoss® server. The extensions for exiting process instances through on-demand, ad-hoc tasks for deviations from the predefined process flow may be implemented in a custom manner by extending the jBPM engine. The interface for initiating such ad-hoc task generation, for displaying explanation about the mappings from ad-hoc TDG to jBPM WFs, and for other proprietary extensions during runtime can be added by extending the process definition archive with appropriate Java® Server Pages (jsp) or HTML files. These can include web pages or frames within the jBPM process page (see FIG. 18), which allow additional interaction and add additional CTM information to the executed jBPM tasks. A “Generate Ad-Hoc Task” button can be added to initiate creation of an ad-hoc task on the server over a web request, forwarding the action the WF Engine or directly to the Tracking WS, which will then send information about the created task to the Tracking WS client and create the respective task in the Office Integrated Task Management Client (OITMC) 510. Thereby, references about the suspended WF may be kept in the created task to allow browsing to the WF in the jBPM web front-end from the OITMC 510 and from the TMWC 520. On the other hand, reference to the generated ad-hoc task may be available in the suspended WF web page (e.g., over link) allowing to navigate and inspect the respective TDG from the front-end of the suspended WF.

The WF Repository WS 559 of FIG. 5 may be implemented as Java® web service, deployed on the JBoss® application server. The WF Repository WS 559 can receive process archives with process files (e.g., in XML), as described above, and store the structures on the Remote WF Model Repository (RWFMR) 580. The tracking repository 560 may be organized as a database (DB) table in a MySQL database. While parent/sub task relationships, delegations, users, and artifacts may be interlinked with foreign key relations, task change history entries may be decoupled from the respective task nodes and contain only the task Ids as strings as well as all task data for a task creation and the subsequent task changes. If a task is deleted on the server, the runtime (tracked) task data is removed through cascading over the foreign key references but the task change history is preserved. The complete task processing can be reconstructed based on the change history data. This feature may be utilized advantageously to establish task sequencing for process definition.

The WF Runtime Storage 570 of FIG. 5 may be delivered as DB schema with the standard jBPM implementation from JBoss®. The DB tables can be extended with additional information for the referenced ad-hoc tasks. The Remote WF Model Repository 580 of FIG. 5 may be implemented, in one example embodiment, through proprietary schema in a MySQL® DB. In order to facilitate relations to deployed instances, this repository may be implemented as additional tables in the WF Runtime Storage schema.

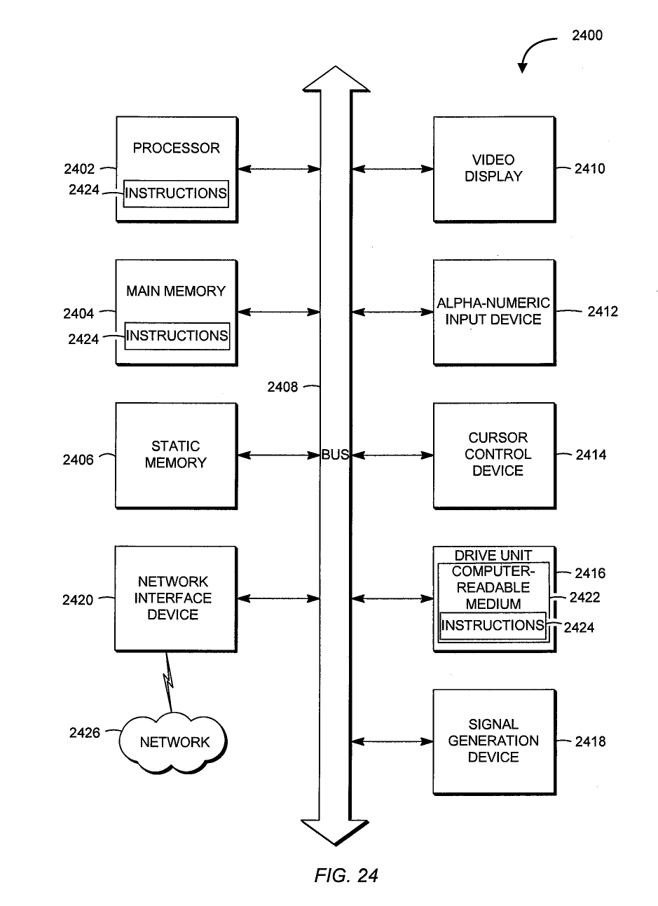

FIG. 24 is a diagrammatic representation of a machine in the example electronic form of a computer system 2400 within which a set of instructions, for causing the machine to perform any one or more of the methodologies discussed herein, may be executed.

In various embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an “Moving Picture Experts Group (MPEG) Layer 3” (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2400 includes a processor 2402 (e.g., a central processing unit (CPU), a graphics processing unit (GPU) or both), a main memory 2404 and a static memory 2406, which communicate with each other via a bus 2408. The computer system 2400 may further include a video display unit 2410 (e.g., a liquid crystal display (LCD) or a cathode ray tube (CRT)). The computer system 2400 also includes an alphanumeric input device 2412 (e.g., a keyboard), a user interface (UI) navigation device 2414 (e.g., a mouse), a disk drive unit 2416, a signal generation device 2418 (e.g., a speaker) and a network interface device 2420.

The disk drive unit 2416 includes a machine-readable medium 2422 on which is stored one or more sets of instructions and data structures (e.g., software 2424) embodying or utilized by any one or more of the methodologies or functions described herein. The software 2424 may also reside, completely or at least partially, within the main memory 2404 and/or within the processor 2402 during execution thereof by the computer system 2400, the main memory 2404 and the processor 2402 also constituting machine-readable media.

The software 2424 may further be transmitted or received over a network 2426 via the network interface device 2420 utilizing any one of a number of well-known transfer protocols (e.g., Hyper Text Transfer Protocol (HTTP)).

While the machine-readable medium 2422 is shown in an example embodiment to be a single medium, the term “machine-readable medium” may be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media. Such medium may also include, without limitation, hard disks, floppy disks, flash memory cards, digital video disks, random access memory (RAMs), read only memory (ROMs), and the like.

A machine-readable medium may be provided having instruction data to cause a machine to monitor ad-hoc events related to a main task, the ad-hoc events associated with end-user task-management activities; collect data associated with the ad-hoc events related to the main task; generate a task pattern based on the collected data; reuse the task pattern to manage a similar task; store a history of reuse of the task pattern; and generate a formal workflow model based on the task pattern and the history of reuse.

The embodiments described herein may be implemented in an operating environment comprising software installed on a computer, in hardware, or in a combination of software and hardware.

Thus, a framework for end-user-driven business process management has been described. Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A system comprising:
a monitor to monitor ad-hoc events related to a main task, the ad-hoc events associated with end-user task-management activities;
a collector to collect data associated with the ad-hoc events related to the main task;
a task pattern generator to generate a task pattern based on the collected data.

2. The system of claim 1, wherein the ad-hoc events originate in a context of a client email application.

3. The system of claim 1, wherein the monitor comprises a task commencement detector to detect an event associated with a commencement of the main task.

4. The system of claim 1, wherein the monitor comprises a task status detector to detect an event associated with a completion of the main task.

5. The system of claim 1, wherein the monitor comprises a task delegation detector to detect an event associated with a sub-task of the main task, the sub-task resulting from a delegation event.

6. The system of claim 1, wherein the main task is associated with a to do item generated by an e-mail client module.

7. The system of claim 1, comprising a task pattern reuse manager to execute the task pattern and to store execution history of the task pattern.

8. The system of claim 1, comprising a workflow model generator to generate a formal workflow model based on the task pattern and the execution history of the task pattern.

9. The system of claim 8, wherein the workflow model generator is to enhance the formal workflow model with comments describing one or more ad-hoc events from the task pattern, the comments associated with respective ad-hoc events from the task pattern based on a mapping scheme.

10. A method comprising:
detecting an ad-hoc event indicative of a main task;
monitoring ad-hoc events related to the main task, the ad-hoc events associated with end-user task-management activities;
collecting the ad-hoc events related to the main task;
generating a task pattern based on the collected ad-hoc events related to the main task.

11. The method of claim 10, comprising storing the task pattern for future use.

12. The method of claim 10, wherein the main task is a to do item originated in an end-user office application.

13. The method of claim 11, wherein the end-user office application is an e-mail client application.

14. The method of claim 10, wherein the ad-hoc events related to the main task include a task delegation event.

15. The method of claim 10, wherein the ad-hoc events related to the main task include an e-mail message related to the main task.

16. The method of claim 10, wherein the generated task pattern includes one or more artifacts associated with the main task.

17. The method of claim 10, comprising generating a formal workflow model based on the task pattern and a mapping scheme.

18. The method of claim 17, wherein the generating of the formal workflow model comprises associating a workflow model entity from the formal workflow with an ad-hoc event from the task pattern.

19. A method comprising:
collecting ad-hoc events related to a main task, the ad-hoc events comprising a task commencing event, a task delegating event, a task progress event, and a task completion event;
arranging the collected ad-hoc events into a task pattern;
generating a formal workflow model utilizing the task pattern and a mapping scheme, the mapping scheme providing association between ad-hoc events and workflow model entities; and
enhancing the formal workflow model with comments describing one or more ad-hoc events from the task pattern, the comments associated with respective ad-hoc events from the task pattern based on the mapping scheme.

20. The method of claim 19, wherein the generating of the formal workflow model includes utilizing execution history of the task pattern.
